(19) United States
(12) Patent Application Publication
(10) Pub. No.: US 2025/0119861 A1
(43) Pub. Date: Apr. 10, 2025

(54) MINIMIZE USER EQUIPMENT REQUESTED POSITIONING REFERENCE SIGNAL MEASUREMENT GAPS FOR POSITIONING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/293,666

(22) PCT Filed: Aug. 31, 2022
(86) PCT No.: PCT/US2022/042240

§ 371 Date: Jan. 30, 2024

(30) Foreign Application Priority Data
Sep. 27, 2021 (GR) 20210100638

(51) Int. Cl. H04W 64/00; H04B 17/318; H04L 5/00; H04W 24/08

(52) U.S. Cl. CPC H04W 64/00; H04B 17/328; H04L 5/0048; H04W 24/08

(57) ABSTRACT

Aspects presented herein may enable a UE to measure a subset of a bandwidth of PRSs, such that the UE may measure the PRSs without retuning bandwidth. In one aspect, a UE measures at least one quality metric associated with one or more channels for one or more PRSs. The UE receives, from a base station, the one or more PRSs via the one or more channels. The UE measures the one or more PRSs using at least one measuring BW of a plurality of measuring BWs, the plurality of measuring BWs being based on at least one of the measured at least one quality metric meeting a quality metric threshold, a BW for the one or more PRSs being greater than or outside of a BW for an ABWP, or a UE system BW being greater than the BW for the one or more PRSs.

### CROSS-REFERENCE TO RELATED APPLICATION

This application claims the benefit of Greek application No. 20210100638, entitled “MINIMIZE USER EQUIPMENT REQUESTED POSITIONING REFERENCE SIGNAL MEASUREMENT GAPS FOR POSITIONING” and filed on Sep. 27, 2021, which is expressly incorporated by reference herein in its entirety.

### TECHNICAL FIELD

The present disclosure relates generally to communication systems, and more particularly, to wireless communications involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus measures at least one quality metric associated with one or more channels for one or more positioning reference signals (PRSs). The apparatus receives, from a base station, the one or more PRSs via the one or more channels. The apparatus measures the one or more PRSs using at least one measuring bandwidth (BW) of a plurality of measuring BWs, the plurality of measuring BWs being based on at least one of the measured at least one quality metric meeting a quality metric threshold, a BW for the one or more PRSs being greater than or outside of a BW for an active bandwidth part (ABWP), or a UE system BW being greater than the BW for the one or more PRSs.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements in accordance with various aspects of the present disclosure.

FIG. 5A is a diagram illustrating an example of downlink-positioning reference signal (DL-PRS) transmitted from multiple transmission reception points (TRPs)/base stations in accordance with various aspects of the present disclosure.

FIG. 5B is a diagram illustrating an example of uplink-sounding reference signal (UL-SRS) transmitted from a UE in accordance with various aspects of the present disclosure.

FIG. 6 is a diagram illustrating an example of estimating a position of a UE based on multi-round trip time (RTT) measurements from multiple base stations or TRPs in accordance with various aspects of the present disclosure.

FIG. 7 is a diagram illustrating an example of DL-PRS transmission, processing, and reporting cycles for multiple UEs in accordance with various aspects of the present disclosure.

FIG. 8A is a diagram illustrating an example of measurement window and processing window in accordance with various aspects of the present disclosure.

FIG. 8B is a diagram illustrating an example of measurement window and processing window in accordance with various aspects of the present disclosure.

FIG. 9 is a diagram illustrating an example of bandwidth parts (BWPs) in accordance with various aspects of the present disclosure.

FIG. 10 is a diagram illustrating examples of PRS measurements with measurement gaps and without measurement gaps in accordance with various aspects of the present disclosure.

FIG. 11 is a diagram illustrating an example of a UE truncating one or more PRSs for PRS measurements in accordance with various aspects of the present disclosure.

FIG. 12A is a diagram illustrating an example of truncating PRS bandwidth in accordance with various aspects of the present disclosure.

FIG. 12B is a diagram illustrating an example of truncating PRS bandwidth in accordance with various aspects of the present disclosure.

FIG. 13 is a diagram illustrating an example of channel energy response (CER) performance versus bandwidth/inverse fast Fourier transform (IFFT) length associated with measuring a subset/portion of the PRS in accordance with various aspects of the present disclosure.

FIG. 14 is a diagram illustrating an example of a UE tuning to a bandwidth greater than an active bandwidth part (ABWP) and less than a UE system bandwidth if bandwidth(s) associated with a set of PRSs is greater than the ABWP but less than the UE system bandwidth in accordance with various aspects of the present disclosure.

FIG. 15 is a diagram illustrating an example of a UE performing multiple positioning frequency layer (PFL) measurements in accordance with various aspects of the present disclosure.

FIG. 16A is a diagram illustrating an example overlap metric in accordance with various aspects of the present disclosure.

FIG. 16B is a diagram illustrating an example overlap metric in accordance with various aspects of the present disclosure.

FIG. 17 is a flowchart of a method of wireless communication in accordance with aspects presented herein.

FIG. 18 is a flowchart of a method of wireless communication in accordance with aspects presented herein.

FIG. 19 is a diagram illustrating an example of a hardware implementation for an example apparatus in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

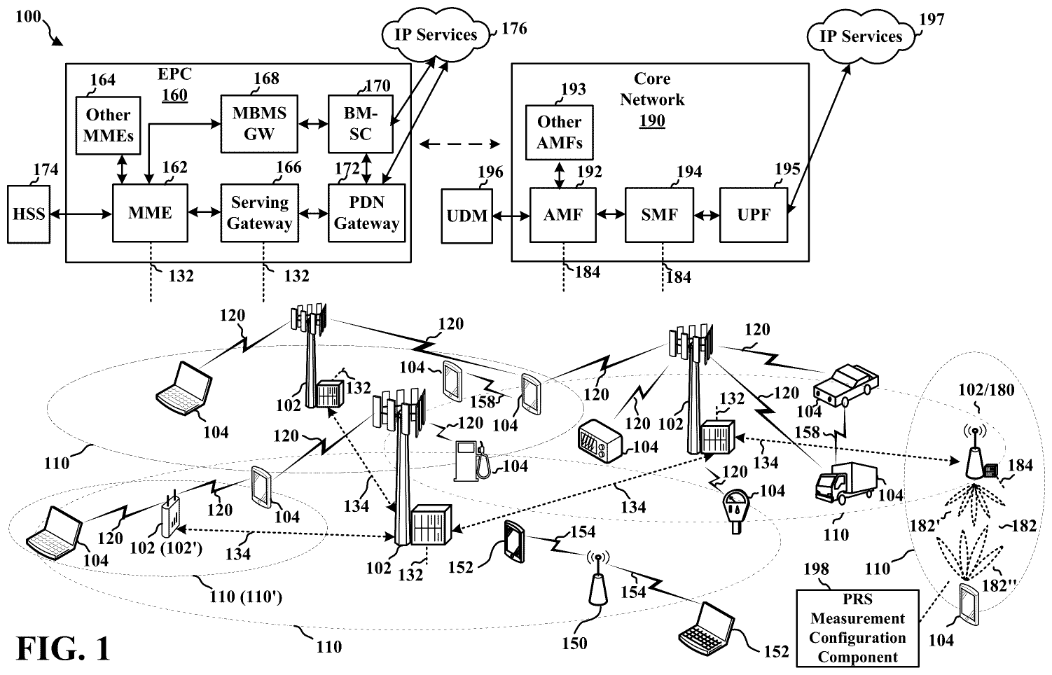

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

Aspects presented herein may improve latency and/or power saving associated with UE positioning. Aspects presented herein may enable a UE to measure a subset/portion of a bandwidth of a set of PRSs if one or more defined conditions are met, such that the UE may measure the set of PRSs without retuning to a larger bandwidth from a default bandwidth (e.g., a bandwidth associated with an ABWP) if the bandwidth of the set of PRSs exceeds the default bandwidth. Aspects presented herein may also enable a UE to determine whether to request or refrain from requesting measurement gaps and/or retune gaps under different scenarios, such that a number of measurement gaps and/or retune gaps configured for the UE may be reduced to improve the reliability and latency of a UE positioning.

In certain aspects, the UE 104 may include a PRS measurement configuration component 198 configured to measure a set of PRSs using different bandwidths based on various defined conditions. In one configuration, the PRS measurement configuration component 198 may be configured to measure at least one quality metric associated with one or more channels for one or more PRSs. In such configuration, the PRS measurement configuration component 198 may receive, from a base station, the one or more PRSs via the one or more channels. In such configuration, the PRS measurement configuration component 198 may measure the one or more PRSs using at least one measuring BW of a plurality of measuring BWs, the plurality of measuring BWs being based on at least one of the measured at least one quality metric meeting a quality metric threshold, a BW for the one or more PRSs being greater than a BW for an ABWP, or a UE system BW being greater than or outside of the BW for the one or more PRSs.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

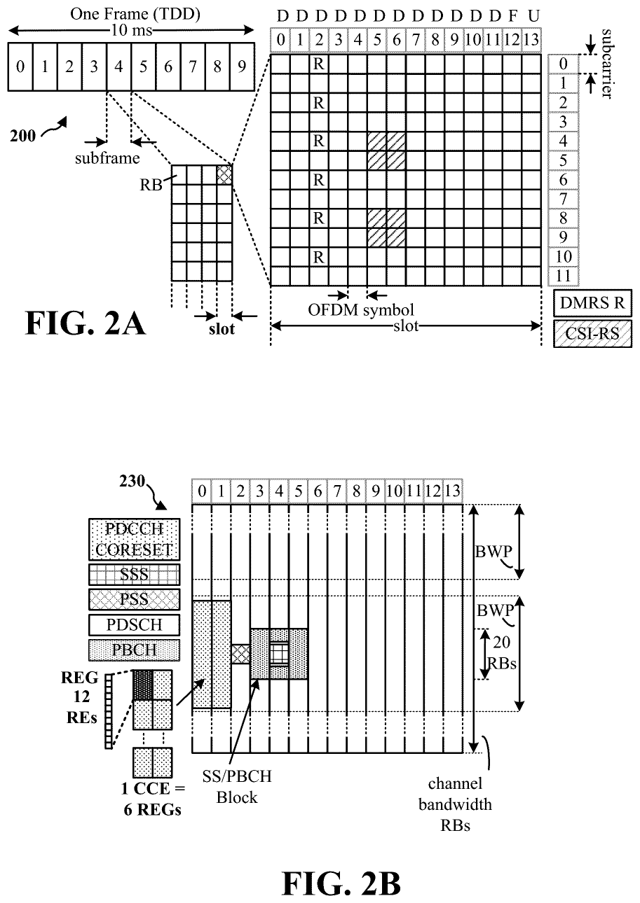

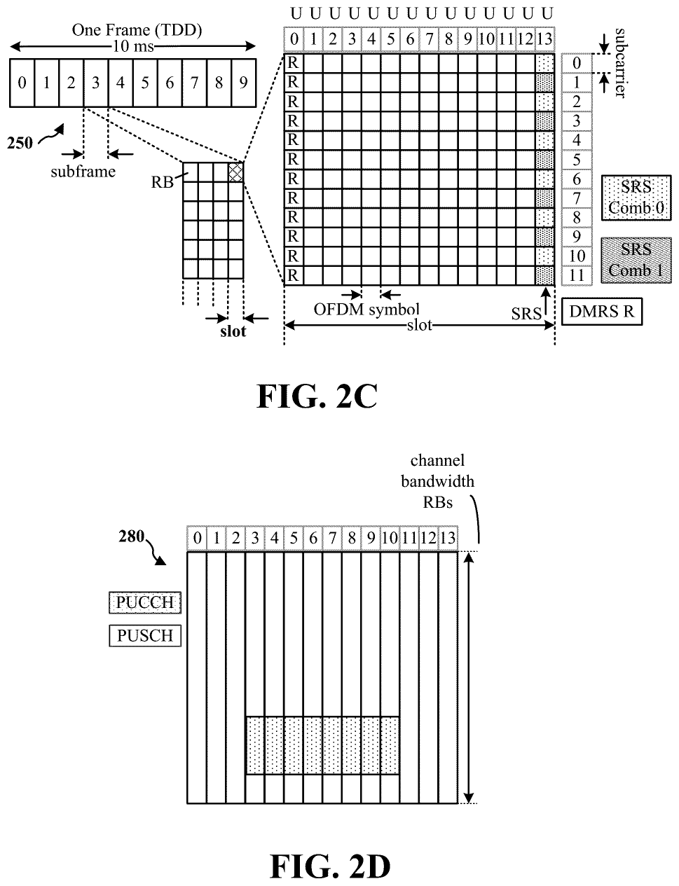

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

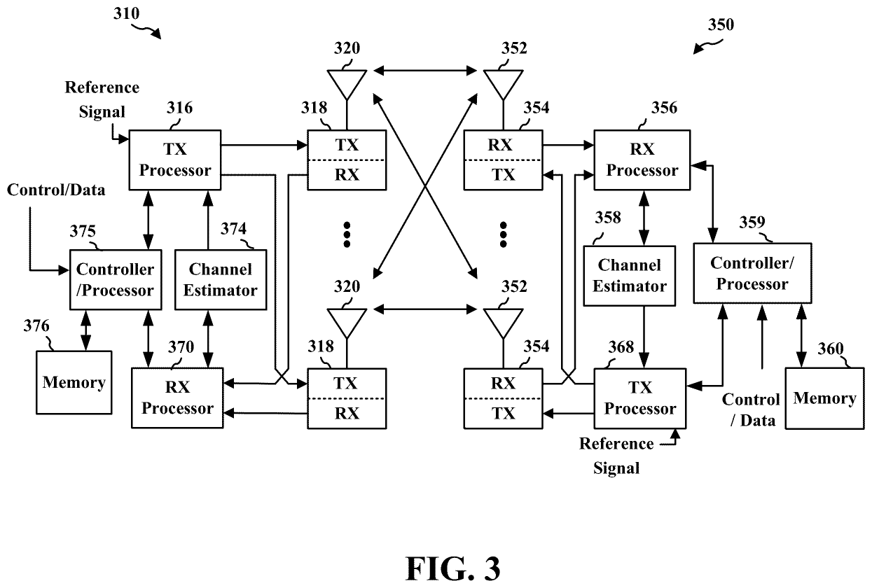

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the PRS measurement configuration component 198 of FIG. 1.

A network may support a number of cellular network-based positioning technologies, such as downlink-based, uplink-based, and/or downlink-and-uplink-based positioning methods. Downlink-based positioning methods may include an observed time difference of arrival (OTDOA) (e.g., in LTE), a downlink time difference of arrival (DL-TDOA) (e.g., in NR), and/or a downlink angle-of-departure (DL-AoD) (e.g., in NR). In an OTDOA or DL-TDOA positioning procedure, a UE may measure the differences between each time of arrival (ToA) of reference signals (e.g., positioning reference signals (PRSs)) received from pairs of base stations, referred to as reference signal time difference (RSTD) or time difference of arrival (TDOA) measurements, and report them to a positioning entity (e.g., a location management function (LMF)). For example, the UE may receive identifiers (IDs) of a reference base station (e.g., a serving base station) and multiple non-reference base stations in assistance data. The UE may then measure the RSTD between the reference base station and each of the non-reference base stations. Based on the known locations of the involved base stations and the RSTD measurements, the positioning entity can estimate a location of the UE. In other words, a position of the UE may be estimated based on measuring reference signals transmitted between the UE and one or more base stations and/or transmission reception points (TRPs) of the one or more base stations. As such, the PRSs may enable UEs to detect and measure neighbor TRPs, and to perform positioning based on the measurement. For purposes of the present disclosure, the suffixes “-based” and “-assisted” may refer respectively to the node that is responsible for making the positioning calculation (and which may also provide measurements) and a node that provides measurements (but which may not make the positioning calculation). For example, an operation in which measurements are provided by a UE to a base station/positioning entity to be used in the computation of a position estimate may be described as “UE-assisted,” “UE-assisted positioning,” and/or “UE-assisted position calculation” while an operation in which a UE computes its own position may be described as “UE-based,” “UE-based positioning,” and/or “UE-based position calculation.”

For DL-AoD positioning, the positioning entity may use a beam report from the UE of received signal strength measurements of multiple downlink transmit beams to determine the angle(s) between the UE and the transmitting base station(s). The positioning entity may then estimate the location of the UE based on the determined angle(s) and the known location(s) of the transmitting base station(s).

Uplink-based positioning methods may include UL-TDOA and UL-AoA. UL-TDOA is similar to DL-TDOA, but is based on uplink reference signals (e.g., sounding reference signals (SRSs)) transmitted by the UE. For UL-AoA positioning, one or more base stations may measure the received signal strength of one or more uplink reference signals (e.g., SRSs) received from a UE on one or more uplink receive beams. The positioning entity may use the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods may include enhanced cell-ID (E-CID) positioning and multi-round-trip-time (RTT) positioning (also referred to as “multi-cell RTT”). In an RTT procedure, an initiator (a base station or a UE) transmits an RTT measurement signal (e.g., a PRS or SRS) to a responder (a UE or a base station), which transmits an RTT response signal (e.g., an SRS or a PRS) back to the initiator. The RTT response signal may include the difference between the ToA of the RTT measurement signal and the transmission time of the RTT response signal, referred to as the reception-to-transmission (Rx-Tx) time difference. The initiator may calculate the difference between the transmission time of the RTT measurement signal and the ToA of the RTT response signal, referred to as the transmission-to-reception (Tx-Rx) time difference. The propagation time (also referred to as the “time of flight”) between the initiator and the responder may be calculated from the Tx-Rx and Rx-Tx time differences. Based on the propagation time and the known speed of light, the distance between the initiator and the responder may be determined. For multi-RTT positioning, a UE may perform an RTT procedure with multiple base stations to enable its location to be determined (e.g., using multilateration) based on the known locations of the base stations. RTT and multi-RTT methods may be combined with other positioning techniques, such as UL-AoA and DL-AoD, to improve location accuracy.

The E-CID positioning method may be based on radio resource management (RRM) measurements. In E-CID, the UE may report the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., a location server, an LMF, or an SLP) may provide assistance data to the UE. For example, the assistance data may include identifiers of the base stations (or the cells/TRPs of the base stations) from which to measure reference signals, the reference signal configuration parameters (e.g., the number of consecutive positioning subframes, periodicity of positioning subframes, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.).

In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and include coordinates (e.g., latitude, longitude, and possibly altitude) or may be civic and include a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence). For purposes of the present disclosure, reference signals may include PRS, tracking reference signals (TRS), phase tracking reference signals (PTRS), cell-specific reference signals (CRS), CSI-RS, demodulation reference signals (DMRS), PSS, SSS, SSBs, SRS, etc., depending on whether the illustrated frame structure is used for uplink or downlink communication. In some examples, a collection of resource elements (REs) that are used for transmission of PRS may be referred to as a “PRS resource.” The collection of resource elements may span multiple PRBs in the frequency domain and one or more consecutive symbol(s) within a slot in the time domain. In a given OFDM symbol in the time domain, a PRS resource may occupy consecutive PRBs in the frequency domain. In other examples, a “PRS resource set” may refer to a set of PRS resources used for the transmission of PRS signals, where each PRS resource may have a PRS resource ID. In addition, the PRS resources in a PRS resource set may be associated with a same TRP. A PRS resource set may be identified by a PRS resource set ID and may be associated with a particular TRP (e.g., identified by a TRP ID). In addition, the PRS resources in a PRS resource set may have a same periodicity, a common muting pattern configuration, and/or a same repetition factor across slots. The periodicity may be a time from a first repetition of a first PRS resource of a first PRS instance to the same first repetition of the same first PRS resource of the next PRS instance. For example, the periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots. A PRS resource ID in a PRS resource set may be associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” In some examples, a “PRS instance” or “PRS occasion” may be one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” and/or a “repetition,” etc.

A “positioning frequency layer (PFL)” (which may also be referred to as a “frequency layer”) may be a collection of one or more PRS resource sets across one or more TRPs that have the same values for certain parameters. Specifically, the collection of PRS resource sets may have a same subcarrier spacing and cyclic prefix (CP) type (e.g., meaning all numerologies supported for PDSCHs are also supported for PRS), the same Point A, the same value of the downlink PRS bandwidth, the same start PRB (and center frequency), and/or the same comb-size, etc. The Point A parameter may take the value of a parameter ARFCN-ValueNR (where “ARFCN” stands for “absolute radio-frequency channel number”) and may be an identifier/code that specifies a pair of physical radio channel used for transmission and reception. In some examples, a downlink PRS bandwidth may have a granularity of four PRBs, with a minimum of 24 PRBs and a maximum of 272 PRBs. In other examples, up to four frequency layers may be configured, and up to two PRS resource sets may be configured per TRP per frequency layer.

The concept of a frequency layer may be similar to component carrier (CC) and BWP, where CCs and BWPs may be used by one base station (or a macro cell base station and a small cell base station) to transmit data channels, while frequency layers may be used by multiple (e.g., three or more) base stations to transmit PRS. A UE may indicate the number of frequency layers it is capable of supporting when the UE sends the network its positioning capabilities, such as during a positioning protocol session. For example, a UE may indicate whether it is capable of supporting one or four PFLs.

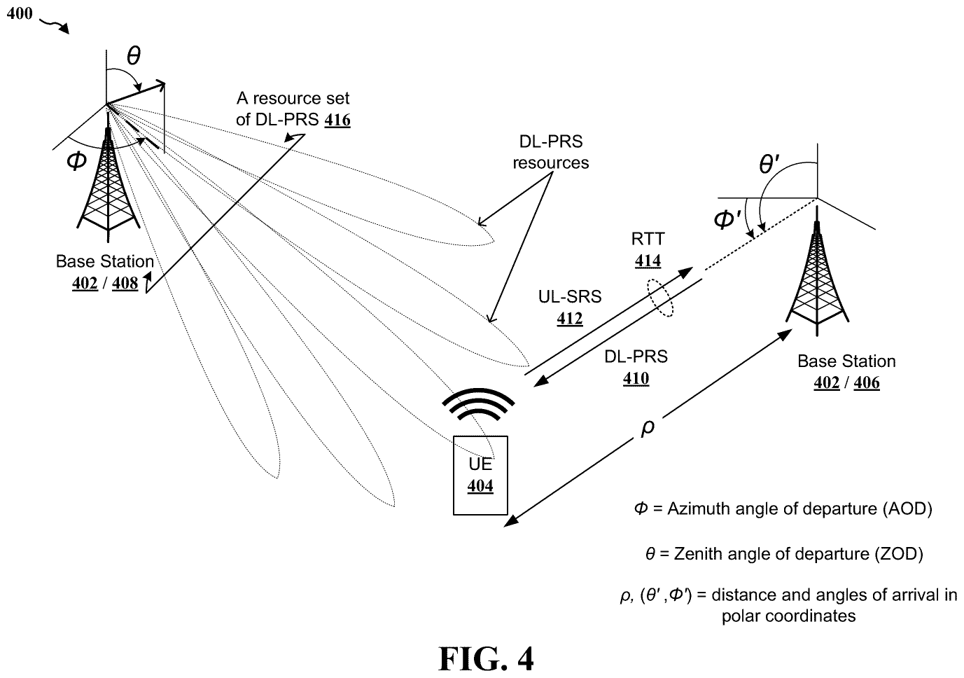

FIG. 4 is a diagram 400 illustrating an example of a UE positioning based on reference signal measurements in accordance with various aspects of the present disclosure. In one example, a location of UE 404 may be estimated based on multi-cell round trip time (multi-RTT) measurements, where multiple base stations 402 may perform round trip time (RTT) measurements for signals transmitted to and received from the UE 404 to determine the approximate distance of UE 404 with respect to each of the multiple base stations 402. Similarly, the UE 404 may perform RTT measurements for signals transmitted to and received from the base stations 402 to determine each base station's approximate distance with respect to the UE 404. Then, based at least in part on the approximate distances of UE 404 with respect to the multiple base stations 402, a location management function (LMF) that is associated with the base stations 402 and/or the UE 404 may estimate the position of UE 404. For example, a base station 406 may transmit at least one downlink positioning reference signal (DL-PRS) 410 to the UE 404, and may receive at least one uplink sounding reference signal (UL-SRS) 412 transmitted from the UE 404. Based at least in part on measuring an RTT 414 between the DL-PRS 410 transmitted and the UL-SRS 412 received, the base station 406 or an LMF associated with the base station 406 may identify the position of UE 404 (e.g., distance) with respect to the base station 406. Similarly, the UE 404 may transmit UL-SRS 412 to the base station 406, and may receive DL-PRS 410 transmitted from the base station 406. Based at least in part on measuring the RTT 414 between the UL-SRS 412 transmitted and the DL-PRS 410 received, the UE 404 or an LMF associated with the UE 404 may identify the position of base station 406 with respect to the UE 404. The multi-RTT measurement mechanism may be initiated by the LMF that is associated with the base station 406/408 and/or the UE 404. A base station may configure UL-SRS resources to a UE via radio resource control (RRC) signaling. In some examples, the UE and the base station (or TRPs of the base station) may report the multi-RTT measurements to the LMF, and the LMF may estimate the position of the UE based on the reported multi-RTT measurements.

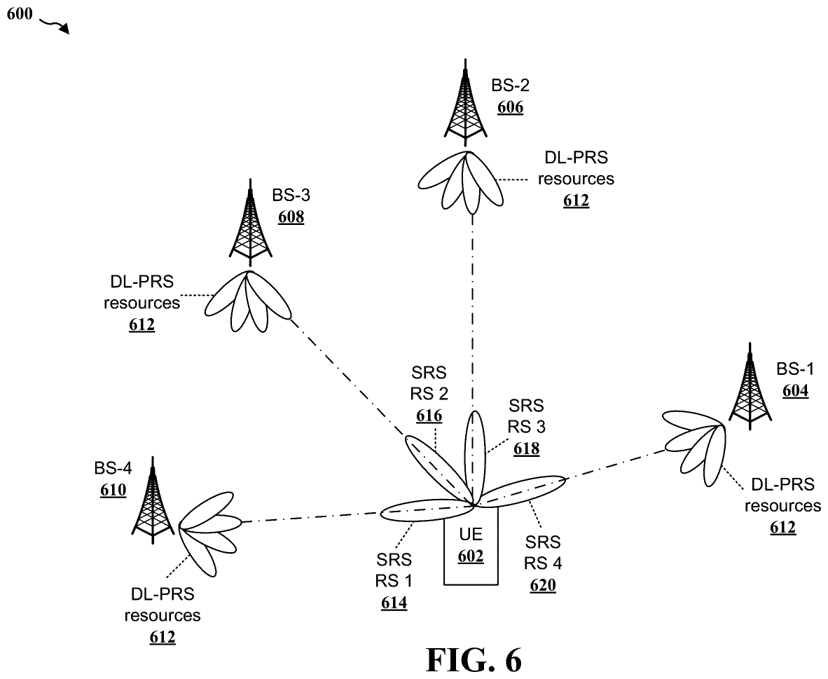

In other examples, a position of a UE may be estimated based on multiple antenna beam measurements, where a downlink angle of departure (DL-AoD) and/or uplink angle of arrival (UL-AoA) of transmissions between a UE and one or more base stations/TRPs may be used to estimate the position of the UE and/or the distance of the UE with respect to each base station/TRP. For example, referring back to FIG. 6, with regard to the DL-AoD, the UE 404 may perform reference signal received power (RSRP) measurements for a set of DL-PRS 416 transmitted from multiple transmitting beams (e.g., DL-PRS beams) of a base station 408, and the UE 404 may provide the DL-PRS beam measurements to a serving base station (or to the LMF associated with the base station). Based on the DL-PRS beam measurements, the serving base station or the LMF may derive the azimuth angle (e.g., Φ) of departure and the zenith angle (e.g., θ) of departure for DL-PRS beams of the base station 408. Then, the serving base station or the LMF may estimate the position of UE 404 with respect to the base station 408 based on the azimuth angle of departure and the zenith angle of departure of the DL-PRS beams. Similarly, for the UL-AoA, a position of a UE may be estimated based on UL-SRS beam measurements measured at different base stations, such as at the base stations 402. Based on the UL-SRS beam measurements, a serving base station or an LMF associated with the serving base station may derive the azimuth angle of arrival and the zenith angle of arrival for UL-SRS beams from the UE, and the serving base station or the LMF may estimate the position of the UE and/or the UE distance with respect to each of the base stations based on the azimuth angle of arrival and the zenith angle of arrival of the UL-SRS beams.

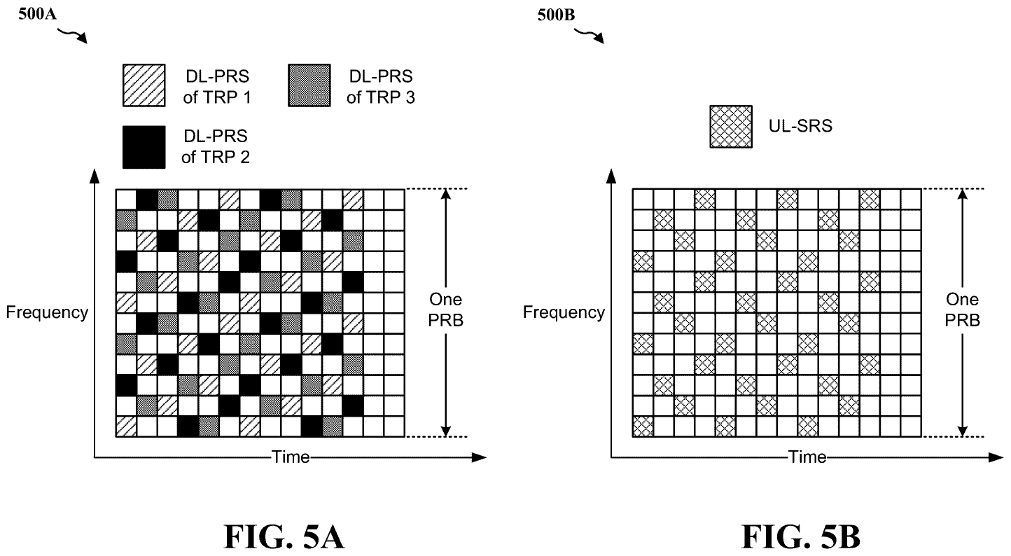

FIG. 5A is a diagram 500A illustrating an example of DL-PRS transmitted from multiple TRPs/base stations in accordance with various aspects of the present disclosure. In one example, a serving base station may configure DL-PRS to be transmitted from one or more TRPs/base stations within a slot or across multiple slots. If the DL-PRS is configured to be transmitted within a slot, the serving base station may configure the starting resource element in time and frequency from each of the one or more TRPs/base stations. If the DL-PRS is configured to be transmitted across multiple slots, the serving base station may configure gaps between DL-PRS slots, periodicity of the DL-PRS, and/or density of the DL-PRS within a period. The serving base station also may configure the DL-PRS to start at any physical resource block (PRB) in the system bandwidth. In one example, the system bandwidth may range from 24 to 276 PRBs in steps of 4 PRBs (e.g., 24, 28, 32, 36, etc.). The serving base station may transmit the DL-PRS in PRS beams, where a PRS beam may be referred to as a “PRS resource” and a full set of PRS beams transmitted from a TRP on a same frequency may be referred to as a “PRS resource set” or a “resource set of PRS,” such as described in connection with FIG. 4. As shown by FIG. 5A, the DL-PRS transmitted from different TRPs and/or from different PRS beams may be multiplexed across symbols or slots.

In some examples, each symbol of the DL-PRS may be configured with a comb-structure in frequency, where the DL-PRS from a base station or a TRP may occupy every N^{th} subcarrier. The comb value N may be configured to be 2, 4, 6, or 12. The length of the PRS within one slot may be a multiple of N symbols and the position of the first symbol within a slot may be flexible as long as the slot consists of at least N PRS symbols. The diagram 500A shows an example of a comb-6 DL-PRS configuration, where the pattern for the DL-PRS from different TRPs/base stations may be repeated after six (6) symbols.

FIG. 5B is a diagram 500B illustrating an example of UL-SRS transmitted from a UE in accordance with various aspects of the present disclosure. In one example, the UL-SRS from a UE may be configured with a comb-4 pattern, where the pattern for UL-SRS may be repeated after four (4) symbols. Similarly, the UL-SRS may be configured in an SRS resource of an SRS resource set, where each SRS resource may correspond to an SRS beam, and the SRS resource sets may correspond to a collection of SRS resources (e.g., beams) configured for a base station/TRP. In some examples, the SRS resources may span 1, 2, 4, 8, or 12 consecutive OFDM symbols. In other examples, the comb size for the UL-SRS may be configured to be 2, 4, or 8.

FIG. 6 is a diagram 600 illustrating an example of estimating a position of a UE based on multi-RTT measurements from multiple base stations or TRPs in accordance with various aspects of the present disclosure. A UE 602 may be configured by a serving base station to decode DL-PRS resources 612 that correspond to and are transmitted from a first base station (BS) 604, a second BS 606, a third BS 608, and a fourth BS 610. The UE 602 may also be configured to transmit UL-SRSs on a set of UL-SRS resources, which may include a first SRS resource 614, a second SRS resource 616, a third SRS resource 618, and a fourth SRS resource 620, such that the serving cell(s), e.g., the first BS 604, the second BS 606, the third BS 608, and the fourth BS 610, and as well as other neighbor cell(s), may be able to measure the set of the UL-SRS resources transmitted from the UE 602. For multi-RTT measurements based on DL-PRS and UL-SRS, as there may be an association between a UE's measurement for the DL-PRS and a base station's measurement for the UL-SRS, the smaller the gap is between the UE's DL-PRS measurement and the UE's UL-SRS transmission, the better the accuracy may be for estimating the position of the UE and/or the UE's distance with respect to each BS.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

In some examples, there may be measurement period specifications specified for PRS-RSTD, PRS-RSRP, and/or UE Rx-Tx time difference which may depend on various factors, such as a UE PRS processing capability and/or a number of samples, etc. In one example, a PRS-RSTD measurement period may be calculated based on the equation below (note similar equations may apply for PRS-RSRP and UE Rx-Tx time difference):

$${T}_{RSTD , Total} = {\sum }_{i = 1}^{L} {T}_{RSTD , i} + ( L - 1 ) * max ( {T}_{effect , i} )$$

$${T}_{RSTD , i} = ( C S S {F}_{P R S , i} * {N}_{R x B e a m , i} * ⌈ \frac{{N}_{PRS , i}^{s l o t}}{{N}_{i}^{′}} ⌉ ⌈ \frac{{L}_{available\_PRS , i}}{{N}_{i}} ⌉ * {N}_{sample} - 1 ) * {T}_{effect , i} + {T}_{last} .$$

$$CSS {F}_{PRS , i} * {N}_{R x B e am , i} * ⌈ \frac{{N}_{PRS , i}^{s l o t}}{{N}_{i}^{′}} ⌉ ⌈ \frac{{L}_{available\_PRS , i}}{{N}_{i}} ⌉ * {N}_{s a m p l e}$$

may correspond to a total number of samples that are to be measured, where a sample may correspond to all the PRS resources within an effective period, denoted as T_{effect,i}. Further, for the last sample the UE may utilize Tₗₐₛₜ=Tᵢ+T_{available_PRS,i}, where Tᵢ may correspond to a reported UE capability related to PRS processing.

In one example, CSSF_{PRS,i} may be a factor that is used to control how a measurement gap (MG) is being shared between positioning and mobility (radio resource management (RRM)) measurements. If the factor is one (1), it may indicate that there is no sharing of the MG instances between the positioning and the RRM measurements. N_{rxbeam} may be an Rx beam sweeping factor. In some examples, the N_{rxbeam} may equal to eight (8) for FR2 and N_{rxbeam} may equal to (1) for FR1. The factor of eight (8) in the above formulation may be based on a conservative assumption that a UE may perform up to eight Rx beam sweeps across eight “group of instances/samples” assuming the UE is keeping a constant Rx beam within each “group of instances/samples.”

$$⌈ \frac{{N}_{PRS , i}^{s l o t}}{{N}_{i}^{′}} ⌉ ⌈ \frac{{L}_{available\_PRS , i}}{{N}_{i}} ⌉$$

may be factors that consider the PRS processing UE capability with regards to a current PFL configuration. In one example, if the UE's capabilities are large enough, these factors may be one (1), and the factor may not contribute to the latency. Nₛₐₘₚₗₑ may be the number of samples/instances (e.g., for a PRS with periodicity of X ms, it may be assumed that at least Nₛₐₘₚₗₑ of periods are specified). T_{effect,i} may correspond to an effective measurement periodicity (which is derived using the MGRP, T_{PRS,i} and the UE's reported capability Tᵢ). For example,

$${T}_{effect , i} = ⌈ \frac{{T}_{i}}{{T}_{available\_PRS , i}} ⌉ * {T}_{available\_PRS , i} ,$$

where T_{available_PRS,i}=LCM (T_{PRS,i},MGRPᵢ), which may consider the alignment of the MG periodicity and the PRS periodicity. Tₗₐₛₜ may be the measurement duration for the last PRS RSTD sample, which may include the sampling time and processing time, Tₗₐₛₜ=Tᵢ+T_{available_PRS,i}.

If a measurement gap for PRS measurements is configured for a UE, a UE DL PRS processing capability may be defined for the UE. In one example, for the purpose of DL PRS processing capability, a duration K microsecond (ms) of DL PRS symbols within a P ms window corresponding to a maximum PRS periodicity in a positioning frequency layer may be calculated by: (1) Type 1 duration calculation with UE symbol level buffering capability, K=Σ_{s∈S}Kₛ, and Kₛ=Tₛ^{end}−Tₛ^{start}; (2) Type 2 duration calculation with UE slot level buffering capability,

$$K = \frac{1}{{2}^{μ}} \vert S \vert ,$$

where S may be a set of slots based on the numerology of the DL PRS of a serving cell within the P ms window in the positioning frequency layer that contains potential DL PRS resources considering the actual nr-DL-PRS-ExpectedRSTD, nr-DL-PRS-ExpectedRSTD-Uncertainty provided for each pair of DL PRS resource sets.

In one example, for Type 1 duration calculation, [Tₛ^{start},Tₛ^{end}] may be the smallest interval in ms within slot s corresponding to an integer number of OFDM symbols based on the numerology of the DL PRS of a serving cell that covers the union of the potential PRS symbols and determines the PRS symbol occupancy within slot s, where the interval [Tₛ^{start},Tₛ^{end}] may consider the actual nr-DL-PRS-ExpectedRSTD, nr-DL-PRS-ExpectedRSTD-Uncertainty provided for each pair of DL PRS resource sets (target and reference). In another example, for Type 2 duration calculation, u may be the numerology of the DL PRS, and |S| may be the cardinality of the set S.

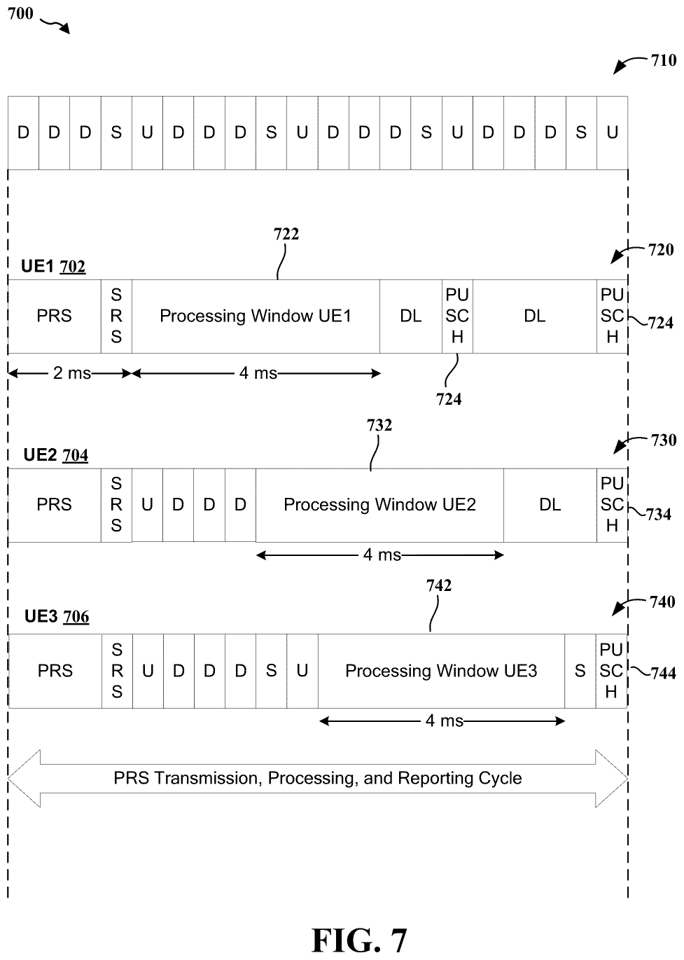

FIG. 7 is a diagram 700 illustrating an example of DL-PRS transmission, processing, and reporting cycles for multiple UEs in accordance with various aspects of the present disclosure. A first UE 702 (“UE 1”), a second UE 704 (“UE 2”), and a third UE 706 (“UE 3”) may be configured to use a “DDDSU” frame structure 710. In one example, the frame structure 710 may be configured with time-division duplex (TDD) 30 kHz SCS, where 30 kHz SCS (μ=1) may have 20 slots per frame and the slot duration may be 0.5 ms. Thus, each block of the DDDSU frame structure 710 may represent a 0.5 ms slot. The DDDSU frame structure 710 may include repetitions of three downlink (D) slots, a special(S) slot, and an uplink (U) slot.

In one example, the first UE 702, the second UE 704, and/or the third UE 706 may receive one or more PRSs in the first three downlink slots of a frame and transmit an SRS in the fourth slot. The PRS(s) and SRS may be received and transmitted, respectively, as part of a downlink-and-uplink-based positioning session, such as an RTT positioning session. The three slots in which the PRS are received (i.e., measured) may correspond to a PRS instance. In some examples, the PRS instance may be contained within a few milliseconds (e.g., 2 ms) of the start of the PRS transmission, processing, and reporting cycle. The SRS transmission (e.g., for a downlink-and-uplink-based positioning procedure) may be close to the PRS instance (e.g., in the next slot).

As shown by the diagram 700, the first UE 702 may be configured with a PRS transmission, processing, and reporting cycle 720, the second UE 704 may be configured with a PRS transmission, processing, and reporting cycle 730, and the third UE 706 may be configured with a PRS transmission, processing, and reporting cycle 740. The PRS transmission, processing, and reporting cycle 720, 730, and 740 may be repeated periodically (e.g., every 10 ms) for some duration of time. Each UE may be expected to send a positioning report (e.g., its respective Rx-Tx time difference measurement) at the end of its PRS transmission, processing, and reporting cycle (e.g., every 10 ms). Each UE may send its report on a PUSCH (e.g., a configured uplink grant). For example, the first UE 702 may send its report on a PUSCH 724, the second UE 704 may send its report on a PUSCH 734, and the third UE 706 may send its report on a PUSCH 744, etc.

In some scenarios, different UEs may be configured with their own PRS processing window (or simply “processing window”), or PRS processing gap (or simply “processing gap”), for processing the PRS measured in the first three slots of the frame (e.g., determine the ToA of the PRS and/or calculate the Rx-Tx time difference measurement, etc.). For example, the first UE 702 may be configured with a processing window 722, the second UE 704 may be configured with a processing window 732, and the third UE 706 may be configured with a processing window 742, etc. In this example, each processing window may be 4 ms in length.

In some examples, each UE's processing window may be offset from the other UEs' processing windows, but may still within the UE's 10 ms PRS transmission, processing, and reporting cycle. In addition, there may still be a PUSCH opportunity for reporting the UE's measurements after the processing window. Even though there is a gap between the PRS instance and the processing window for the second UE 704 and the third UE 706, because of the short length of their respective PRS transmission, processing, and reporting cycles 730 and 740, there may be a limited aging between the measurement and the reporting.

A technical advantage of configuring the UEs with offset processing windows may be greater spectrum utilization. Rather than all of the UEs processing the PRS at the same time right after the PRS instance (and SRS transmission), and therefore not processing other signals, different UEs may continue to transmit and receive while other UEs do not.

In some examples, a processing window may be a time window after the time the one or more PRSs are received and measured by a UE. In other words, the processing window may be a period of time for a UE to process the PRS (e.g., to determine the ToA of the PRS for an Rx-Tx time difference measurement or an RSTD measurement) without having to measure any other signals. Thus, a processing window may also be referred to as a period of time during which the UE prioritizes PRS over other channels, which may include prioritization over data (e.g., PDSCH), control (e.g., PDCCH), and any other reference signals. There may, however, as shown in FIG. 7, be a gap between the time of the measurement and the processing window.

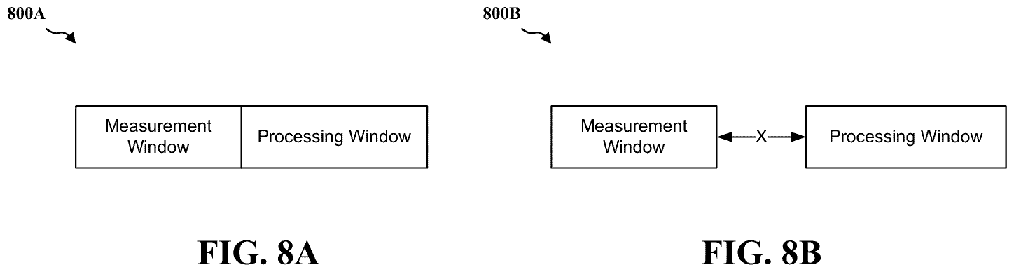

In one example, as shown by a diagram 800A of FIG. 8A, a processing window may be configured to be adjacent to a measurement window. In another example, as shown by a diagram 800B of FIG. 8B, there may be a gap between a processing window and a measurement window. A processing window, or a processing gap, may be different from a measurement window (or a “measurement gap”). In some examples, in a processing window, there may be no retune gaps as in a measurement gap. A retune gap may be referred to as a retune BWP gap in which a UE may use a retune gap for performing a BWP switching (e.g., switch from one BWP to another BWP). Thus, the UE may not change its BWP and instead continue with the BWP it had before the processing window. In addition, a location server (e.g., an LMF) may determine a processing window, and the UE may not specify a processing window to send an RRC request to the serving base station and wait for a reply. As such, processing windows may reduce the signaling overhead and the latency. Information related to a PRS processing window may be provided in the unicast assistance data the UE receives. A processing window may be associated with one or more PFLs, one or more PRS resource sets, one or more PRS resources, or any combination thereof.

In some examples, a UE may include a request for a specific processing window in an LPP Assistance Data Request message. Alternatively, the UE may include PRS processing window information in an LPP Provide Capabilities message. For example, a UE may include the processing window request for “tight” PRS processing cases (e.g., where there is limited time between the measured PRS instance and the measurement report). The request may include a length of time for a PRS processing window that the UE needs for the low-latency PRS processing applications. For example, the UE may need 4 ms of processing time for a PRS instance with ‘X’ PRS resources sets, resources, or symbols. The location server may use this recommendation to send assistance data to the UE that are associated to a specific PRS processing window.

The processing window information configured to the UE and/or recommended by the UE may include (1) an offset with respect to (a) the start of a PRS instance or offset (e.g., the processing window for the second UE 704 in FIG. 7 has an offset of 4 ms from the start of the PRS instance), (b) the end of a PRS instance (e.g., the processing window for the third UE 706 in FIG. 7 has an offset of 3.5 ms from the end of the PRS instance), (c) a PRS resource offset, (d) a PRS resource set offset, and/or (e) a slot, subframe, or frame boundary (e.g., the processing window for the second UE 704 in FIG. 7 has an offset of 4.5 ms from the start of the frame), (2) a length and/or an end time of the processing window, (3) whether the processing window is per UE, per band, per band combination (BC), per frequency range (e.g., FR1 or FR2), whether it affects LTE, and/or (4) how many PRS resources, resource sets, or instances can be processed within a processing window of such a length. In some cases, the location of the start/offset of the processing window may depend on the UE ID.

To configure a UE with a processing window, the location server (e.g., an LMF) may first send an on demand PRS configuration to the UE's serving base station and a suggestion or recommendation or demand or request for a processing window for the UE. Note that the location server may not need to send the requested processing window at the same time as (e.g., in the same message) the on demand PRS configuration. Then, the serving base station may send a response to the location server. The response may be an acceptance of the requested processing window or a configuration of a different processing window. Then, the location server sends assistance data to the UE for the positioning session. The assistance data includes the PRS configurations and the associated processing window.

In some cases, a UE may utilize autonomous processing windows (i.e., autonomous PRS prioritization). In such cases, after a PRS instance, if there is no measurement gap configured, the UE may drop or disregard all other traffic for some period of time without notifying the serving base station. In an aspect, there may be a maximum window inside which the UE is permitted to perform these autonomous PRS prioritizations. As one example, the UE may be expected to finish PRS processing within ‘X’ ms (e.g., 6 ms) after the end of the PRS instance, and inside that ‘X’ ms, the UE may select a period of ‘Y’ ms (where ‘Y’ less than ‘X,’ e.g., 4 ms) during which the UE autonomously prioritizes PRS over other channels. It will be up to the UE to drop or disregard any other channels and processes (e.g., CSI processes) during this window—the serving base station will not refrain from transmitting to the UE.

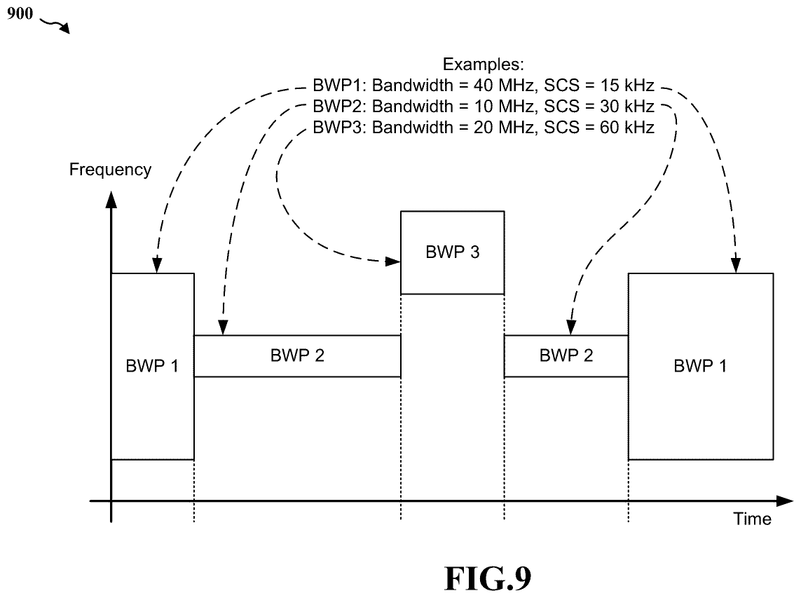

FIG. 9 is a diagram 900 illustrating an example of bandwidth parts (BWPs) in accordance with various aspects of the present disclosure. A channel bandwidth, or a system bandwidth, may be divided into multiple BWPs. A BWP may be a contiguous set of resource blocks (RBs) selected from a contiguous subset of common RBs for a given numerology (u) on a given carrier. In some examples, a maximum of four BWPs may be specified in the downlink and the uplink. In other words, a UE may be configured with up to four BWPs on the downlink, and/or up to four BWPs on the uplink. A UE may activate one BWP (e.g., uplink or downlink) at a given time (which may be referred to as an “active BWP” or “ABWP”), where the UE may receive or transmit over one BWP at a time. On the downlink, the bandwidth of each BWP may be greater than or equal to the bandwidth of an SSB, but it may or may not contain the SSB. In some examples, based on bandwidth adaptation (BA), the receive and transmit bandwidth of a UE may be adjusted (e.g., to a subset of total cell bandwidth). For example, a UE may use a narrower BW (e.g., BWP 2) for monitoring control channels and to receive small/medium amount of data (to save power), and the UE may switch to a full or larger BW (e.g., BWP 1) when large amounts of data are to be scheduled. The BA may be achieved by configuring the UE with BWP(s) and indicating to the UE which of the configured BWPs is currently the active one.

When a UE is being configured with an active BWP (ABWP), the bandwidth of the ABWP may be equal to or less than the UE system BW. The ABWP may include a set of resource blocks (RBs) in which a communication link is established. One or more SL/UL data may be scheduled based on the ABWP, and the UE may be specified to tune and measure the ABWP. For example, as shown by FIG. 9, if the UE is switching from BWP 1 to BWP 2, the UE may specify a gap to perform the switch. In other words, to change any BWP, a UE may specify retune time. The UE system BW may be associated with an RF capability of the UE for decoding a maximum number of RBs and/or BW. As such, the UE system BW may equal to or greater than a configured BWP (e.g., the ABWP). In some scenarios, as a UE may spend more power tuning to a larger BW, it may be advisable for the UE to tune to ABWP at any given point of time.

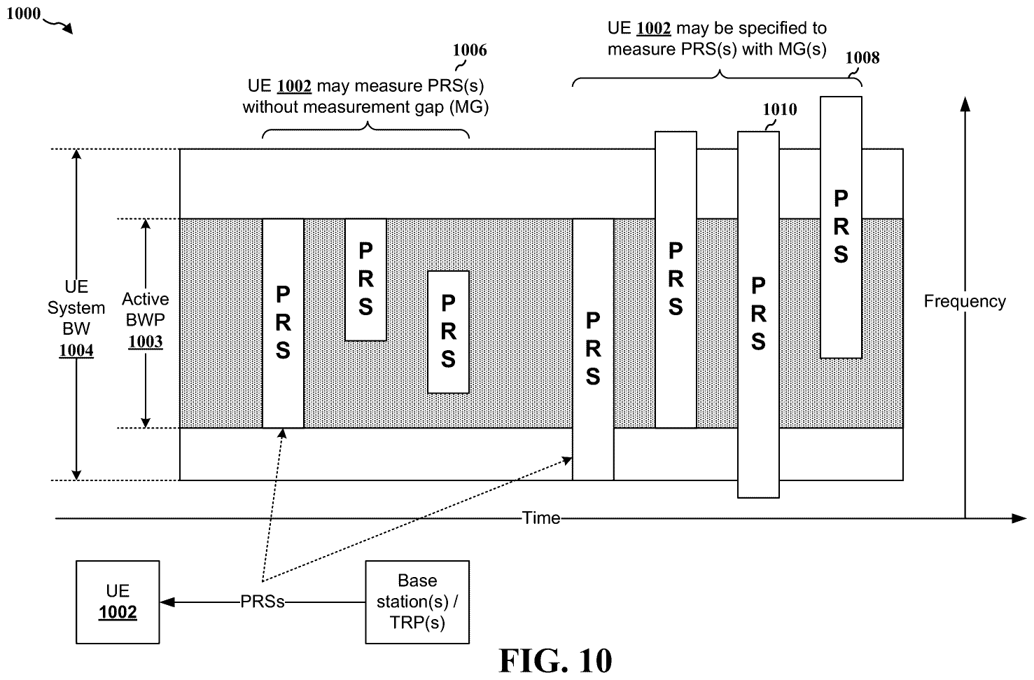

FIG. 10 is a diagram 1000 illustrating examples of PRS measurements with measurement gaps and without measurement gaps in accordance with various aspects of the present disclosure. A UE 1002 may be configured with an ABWP 1003, where the bandwidth of the ABWP 1003 may be smaller than the UE system bandwidth 1004. The UE 1002 may be configured to tune to an ABWP as a default to conserve power. In one example, the UE 1002 may receive a set of PRSs associated with a positioning session, such as from one or more base station(s) and/or transmission and reception points (TRPs). As shown at 1006, if the set of PRSs (e.g., which may be associated with a PFL) that is to be measured by the UE 1002 is the same or subset of the ABWP 1003, the UE 1002 may measure the set of PRSs without specifying measurement gaps. In other words, if the bandwidth(s) of the set of PRSs to be measured by the UE 1002 is within the bandwidth of the ABWP 1003, as the UE 1002 may already be tune to the ABWP 1003 (e.g., as a default), the UE 1002 may measure the set of PRSs without retune to another bandwidth. As such, the UE 1002 may perform PRS measurement without a measurement gap, which may also be referred to as “gap less PRS measurement(s).”

In another example, as shown at 1008, if the set of PRSs that is to be measured by the UE 1002 is not the same or a subset of the ABWP 1003, e.g., the bandwidth(s) of the set of PRSs exceed the bandwidth of the ABWP 1003 and/or partially overlap with the bandwidth of the ABWP 1003, the UE 1002 may measure the set of PRSs with one or more measurement gaps as the UE 1002 may specify time to tune to a larger bandwidth (from the default ABWP 1003). For example, to measure a PRS shown at 1010, as the bandwidth of this PRS exceeds the bandwidth of the ABWP 1003 (e.g., the default bandwidth of the UE), the UE 1002 may be specified to retune its measuring bandwidth to be as close to the bandwidth of this PRS as possible (e.g., retune to the full UE system bandwidth 1004). As such, the UE 1002 may request a serving base station to configure the UE 1002 with a measurement gap for measuring this PRS, such that the UE 1002 may have sufficient time to perform the retune. In some examples, PRS measurements with one or more measurement gaps may be referred to as “gap specified PRS measurement(s)” and/or “gap needed PRS measurement(s).”

Aspects presented herein may improve latency and/or power saving associated with UE positioning. Aspects presented herein may enable a UE to measure a subset/portion of a bandwidth of a set of PRSs if one or more defined conditions are met, such that the UE may measure the set of PRSs without retuning to a larger bandwidth from a default bandwidth (e.g., a bandwidth associated with an ABWP) if the bandwidth of the set of PRSs exceeds the default bandwidth. Aspects presented herein may also enable a UE to determine whether to request or refrain from requesting measurement gaps and/or retune gaps under different scenarios, such that a number of measurement gaps and/or retune gaps configured for the UE may be reduced to improve the reliability and latency of a UE positioning.

In one aspect of the present disclosure, if bandwidth(s) associated with a set of PRSs is greater than an ABWP and channel condition of the channel (e.g., quality metric(s) associated with the channel) for receiving the set of PRSs meets a threshold, a UE may be configured to measure a subset/portion of the bandwidth(s) of the set of PRSs, e.g., the subset/portion of the bandwidth(s) that overlap with the ABWP. In other words, from the UE's perspective, the UE may truncate a PRS bandwidth and measure the truncated PRS bandwidth.

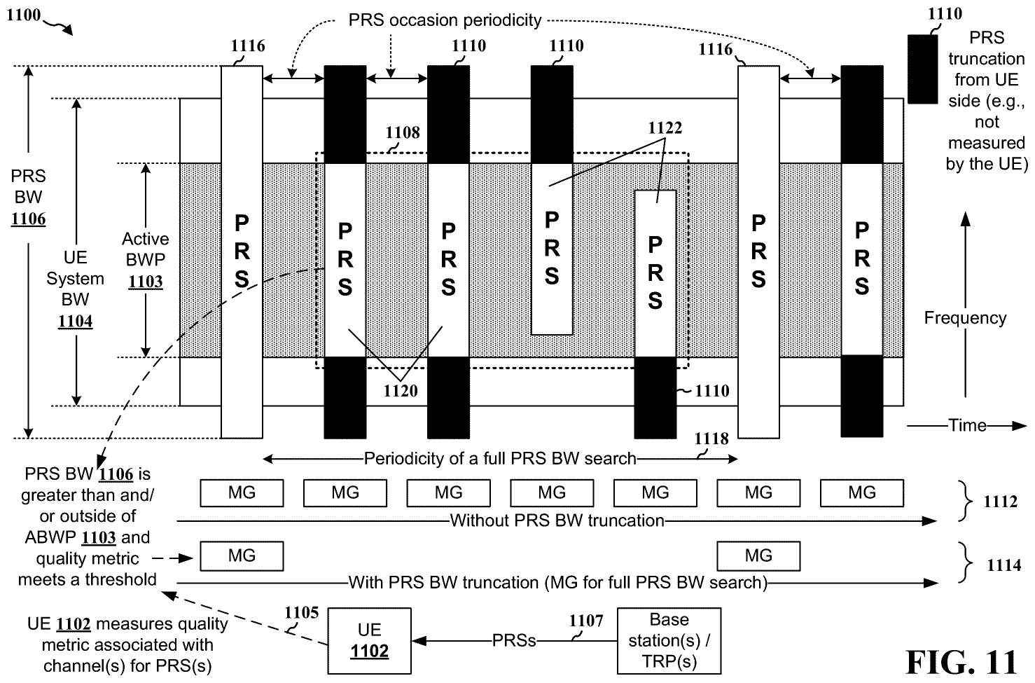

FIG. 11 is a diagram 1100 illustrating an example of a UE truncating one or more PRSs for PRS measurements in accordance with various aspects of the present disclosure. A UE 1102 may be configured with an ABWP 1103, where the bandwidth of the ABWP 1103 may be smaller than the UE system bandwidth 1104. The UE 1102 may be configured to tune to the ABWP 1103 for a default bandwidth to conserve power (e.g., the UE 1102 monitors/measures the channel using the bandwidth of the ABWP 1103).

In one example, at 1105, the UE 1102 may measure a quality metric associated with one or more channels for a set of PRSs (e.g., for receiving/monitoring the set of PRSs), where the set of PRSs may be associated with a positioning session. Then, at 1107, the UE 1102 may receive the set of PRSs, such as from one or more base station(s) and/or TRPs.

As shown at 1108, if the bandwidth of the set of PRSs (hereafter “PRS BW 1106”) that is to be measured by the UE 1102 is greater than the bandwidth of the ABWP 1103 (e.g., PRS BW 1106>ABWP 1103) and/or the PRS BW 1106 is “outside of” or exceeds the ABWP 1103 at least on one end of the bandwidth (e.g., the PRS BW 1106 fully overlaps with the ABWP 1103 and extends through the ABWP 1103 at least on one end as shown at 1120, or the PRS BW 1106 partially overlaps with the ABWP 1103 and extends through the ABWP 1103 on one end as shown at 1122), and the channel condition (e.g., the quality metric) associated with channel(s) for the set of PRSs meets a threshold (e.g., a quality metric threshold), the UE 1102 may be configured to measure a subset/portion of the PRSs, such as the subset/portion that overlaps with the ABWP 1103. For example, the UE may use a measuring bandwidth that equals to an intersection of the PRS BW 1106 and ABWP 1103. In other words, the UE 1102 may truncate a portion of a PRS or a PRS BW from measurement, such as shown at 1110.

For purposes of the present disclosure, “one end” of the bandwidth may refer to a beginning frequency or an ending frequency of the bandwidth. For example, the ABWP 1103 may have a frequency range between 1000 MHz and 1020 MHz. Thus, one end of the ABWP 1103 may be the 1000 MHz end or the 1020 MHz end. In other words, if the PRS BW 1106 is “outside of” or exceeds the ABWP 1103 at least on one end of the bandwidth, it may mean that the highest frequency in the frequency range of the PRS BW 1106 is higher than the highest frequency in the frequency range of the ABWP 1103, the lowest frequency in the frequency range of the PRS BW 1106 is lower than the lowest frequency in the frequency range of the ABWP 1103, or both.

In one example, the quality metric may include signal-to-noise ratio (SNR), signal-to-interference-and-noise ratio (SINR), reference signal received power (RSRP), and/or line-of-sight (LOS) or non-line-of-sight (NLOS) condition associated with the channel(s) for receiving the set of PRSs. For example, the quality metric may be the SNR of the channel and the threshold may be an SNR threshold. Thus, the UE may be configured to measure a subset/portion of the PRSs if the SNR/SINR of the channel is greater than or equal to the SNR/SINR threshold (e.g., SNR/SINR of the channel≥SNR/SINR threshold). In another example, the quality metric may be associated with whether the channel is under an LOS condition or an NLOS condition, where the UE may be configured to measure a subset/portion of the PRSs if the channel is LOS, and the UE may measure the full PRS BW if the channel is NLOS, etc.

When the channel condition is good (e.g., the SNR/SINR is below the SNR/SINR threshold or the channel is under an LOS condition, etc.), the UE 1102 may afford to reduce the PRS BW without effecting measurement results. Thus, the UE 1102 may truncate the PRS BW 1106 to fit the ABWP 1103 for measurement purposes, which may avoid/minimize a number of measurement gaps used by the UE 1102 as the UE 1102 may perform BWP switches less often. For example, as shown at 1112, the UE 1102 may specify a measuring gap for each PRS measuring occasion if the UE 1102 is configured to measure the full PRS BW 1106 for the set of PRSs, where the UE 1102 may use measuring gaps to switch from ABWP 1103 to a bandwidth as close to the PRS BW 1106 as possible. For example, the UE 1102 may switch to the UE system bandwidth 1104 if the PRS BW 1106 is greater than the UE system bandwidth 1104. On the other hand, as shown at 1114, if the UE 1102 is configured to measure a subset/portion of the PRS, as the number of bandwidth (or BWP) switching may be reduced, a serving base station may configure less measuring gaps for the UE.

In some examples, as shown at 1116, the UE 1102 may be configured to perform a full PRS bandwidth search/measurement after a number of PRS measurements to verify the bandwidth of the PRS (e.g., whether it still overlaps with the ABWP 1103) and/or to check the condition of the channel (e.g., whether the SNR still meets the threshold). For example, as shown at 1118, the UE 1102 may be configured to perform a periodic full PRS BW searches/measurements, where the UE 1102 may perform a full PRS BW searches/measurement after X (e.g., 4) PRS measurements, after a time period (e.g., 10 ms), and/or for everyone X^{th} (e.g., fifth) PRS, etc. As the UE 1102 may be specified to perform at least a bandwidth (or BWP) switching when performing the full PRS BW search/measurement, the UE 1102 may request a base station for a measurement gap during these full PRS BW search/measurement instances, such as shown at 1114.

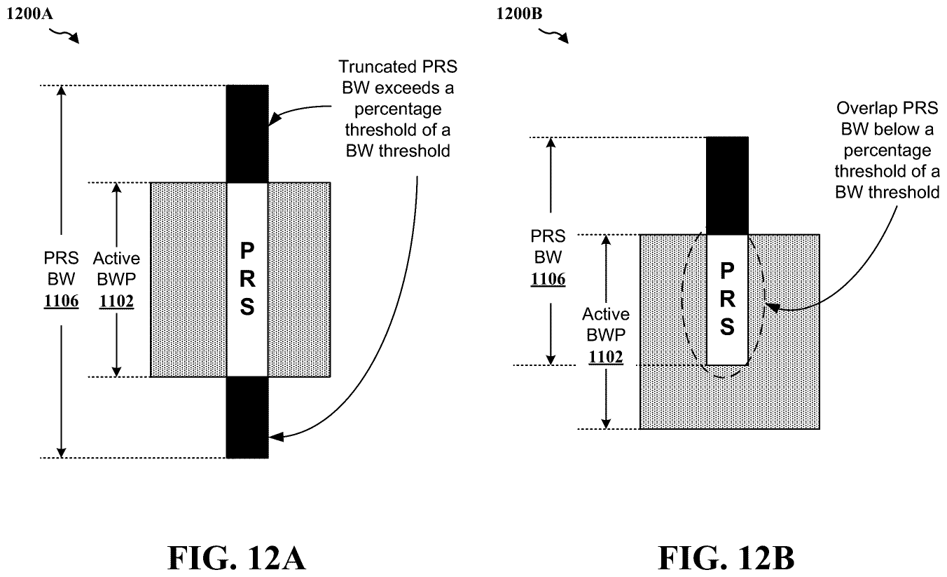

In another example, the UE 1102 may be configured with a maximum limit/threshold on the amount of PRS BW 1106 that may be truncated by the UE 1102 (e.g., not measured by the UE) and/or a minimum overlap between the ABWP 1103 and the PRS 1106. If the UE 1102 is unable to meet the maximum limit/threshold and/or the minimum overlap, the UE 1102 may not truncate the PRS BW 1106 (e.g., the UE 1102 may be configured to measure the full PRS BW 1106 or as close to the full PRS BW 1106 as possible if the PRS BW 1106 is greater than the UE 1102 system bandwidth 1104). For example, as shown by a diagram 1200A of FIG. 12A, if the truncated PRS BW exceeds a percentage threshold (e.g., 30% of the PRS BW 1106, 40% of the ABWP 1103, etc.) or a BW threshold (e.g., 8 MHz), the UE 1102 may be configured not to truncate the PRS BW 1106 (e.g., the UE 1102 may not measure a subset/portion of the PRS BW 1106). In another example, as shown by a diagram 1200B of FIG. 12B, if the PRS BW 1106 does not overlap the ABWP 1103 by a percentage threshold (e.g., by 50% of the ABWP 1103) or a BW threshold (e.g., by 8 MHz), the UE 1102 may be configured not to truncate the PRS BW 1106 (e.g., the UE 1102 may not measure a subset/portion of the PRS BW 1106).

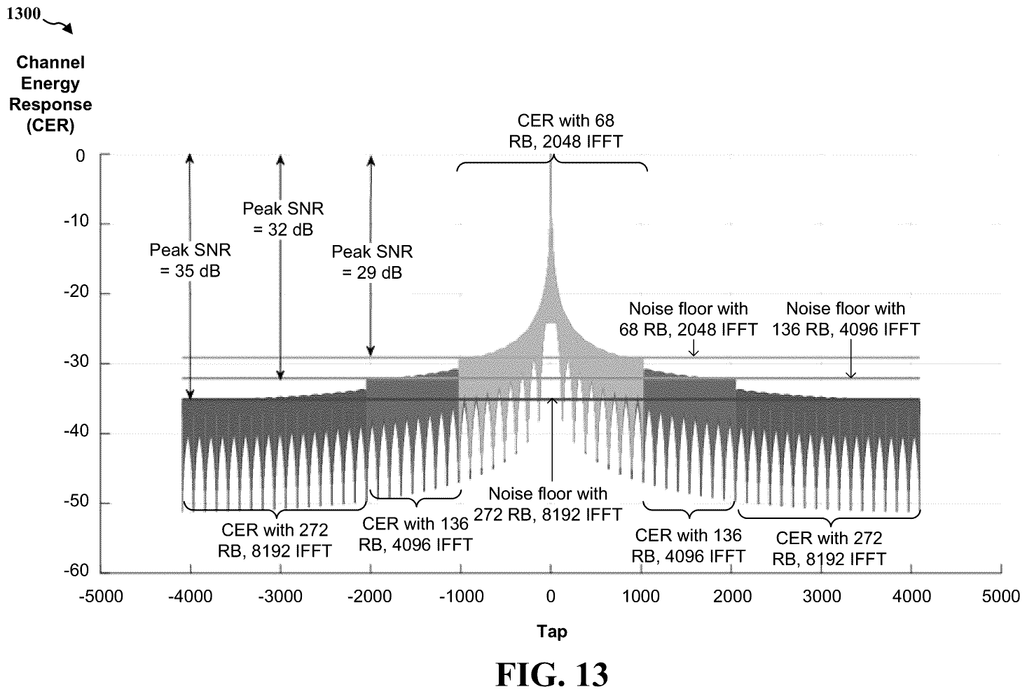

FIG. 13 is a diagram 1300 illustrating an example of channel energy response (CER) performance versus bandwidth/inverse fast Fourier transform (IFFT) length associated with measuring a subset/portion of the PRS in accordance with various aspects of the present disclosure. Under a good SNR condition, a UE (e.g., the UE 1102) may be able to reduce the PRS BW (e.g., the PRS BW 1106) without compromising the results or without effecting the result significantly. For example, the diagram 1300 shows the performance loss of peak SNR of CER, where there may be approximately 3 dB loss for every half bandwidth reduction. If a false alarm threshold is configured to be an order of 14 to 20 dB, there may be a good margin available to reduce the bandwidth. In other words, the UE may still be able to measure PRSs and/or perform UE positioning accurately with PRS BW reduced.

In another aspect of the present disclosure, if bandwidth(s) associated with a set of PRSs is greater than an ABWP but less than (or equal to) the UE system bandwidth, a UE may be configured to tune to a bandwidth greater than ABWP and less than UE system bandwidth. For example, the UE may tune to the PRS BW and remain in the PRS BW throughout the PRS/positioning session, or the UE may tune to the PRS BW prior to every PRS measuring occasion.

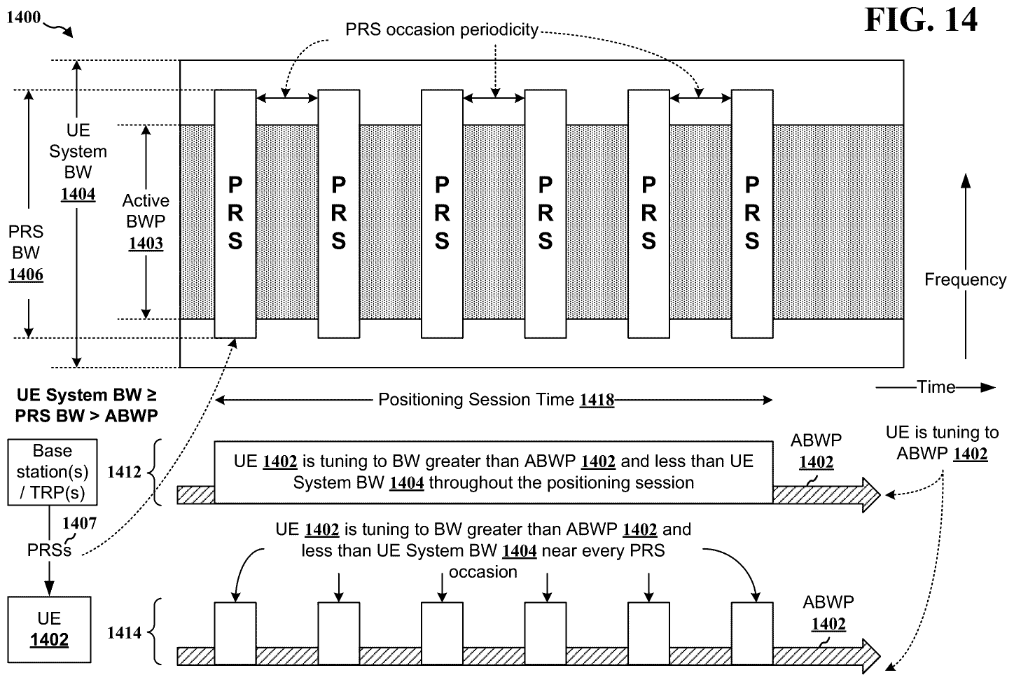

FIG. 14 is a diagram 1400 illustrating an example of a UE tuning to a bandwidth greater than ABWP and less than a UE system bandwidth if bandwidth(s) associated with a set of PRSs is greater than the ABWP but less than the UE system bandwidth in accordance with various aspects of the present disclosure. A UE 1402 may be configured with an ABWP 1403, where the bandwidth of the ABWP 1403 may be smaller than a UE system bandwidth 1404. The UE 1402 may be configured to tune to the ABWP 1403 for a default bandwidth to conserve power (e.g., the UE 1402 monitors/measures the channel using the bandwidth of the ABWP 1403).

In one example, at 1407, the UE 1402 may receive a set of PRSs associated with a positioning session, such as from one or more base station(s) and/or TRPs. In one aspect, if the bandwidth of the set of PRSs (hereafter “PRS BW 1406”) that is to be measured by the UE 1402 (e.g., as part of a positioning session or a PRS measurement session) is greater than the bandwidth of the ABWP 1403 and is less than (or equal to) the UE system bandwidth 1404 (e.g., UE system bandwidth 1404≥PRS BW 1406>ABWP 1403), as the UE 1402 may not be able to decode anything beyond the ABWP 1403 if the UE 1402 is tuned to the ABWP 1403, the UE 1402 may be configured to tune to a measuring bandwidth that is greater than the ABWP 1403 and equal to or smaller than the UE system bandwidth 1404.

In one example, as shown at 1412, the UE 1402 may be configured to tune to a measuring bandwidth greater than the ABWP 1403 and smaller than the UE system bandwidth 1404 throughout a positioning session 1418. For example, the UE 1402 may tune from the ABWP 1403 (e.g., the default measuring bandwidth) to the PRS BW 1406, which is greater than the ABWP 1403, and there may be no change in the serving cell ABWP 1403. Then, the UE 1402 may be configured to remain in the PRS BW 1406 throughout the positioning session 1418. After the set of PRSs for the positioning session 1418 is measured, the UE 1402 may retune its measuring bandwidth back to the ABWP 1403. In such a configuration, the UE 1402 may request one set of retune gaps/BWP switch gaps from the serving base station for switching from the ABWP 1403 to the PRS BW 1406 and switching back to the ABWP 1403 (after measurement). While there may be a power penalty for the UE 1402 to move to a higher bandwidth (e.g., the PRS BW 1406), the UE 1402 may specify one set of BWP retune gaps instead of multiple sets of BWP retune gaps in a positioning session or a PRS measurement session, which may improve the latency and reliability for PRS measurements.

In another example, as shown at 1414, the UE 1402 may be configured to tune to a measuring bandwidth greater than the ABWP 1403 and smaller than the UE system bandwidth 1404 near to (or prior to) one or more PRS measuring occasions in a positioning session 1418, and there may be no change in the serving cell ABWP 1403. For example, if the UE 1402 is configured to measure a set of PRSs that includes PRSs #1 to #6, the UE 1402 may tune from the ABWP 1403 (e.g., the default measuring bandwidth) to the PRS BW 1406 before measuring PRS #1, measure the PRS #1 based on the PRS BW 1406, and retune back to the ABWP 1403 after measuring the PRS #1. Similarly, for measuring PRS #2, the UE 1402 may tune from the ABWP 1403 to the PRS BW 1406 before measuring PRS #2, measure the PRS #2 based on the PRS BW 1406, and retune back to the ABWP 1403 after measuring the PRS #2. The UE 1402 may repeat the same process for measuring PRSs #1 to #6. In such a configuration, the UE 1402 may request multiple sets of retune gaps/BWP switch gaps from the serving base station for switching from the ABWP 1403 to the PRS BW 1406 and switching back to the ABWP 1403 (e.g., six sets of retune gaps for six PRS measurement occasions). While such configuration may increase a number of sets of BWP retune gaps configured for the UE 1402, the power penalty may be smaller for the UE 1402 compared to the configuration discussed at 1412 (e.g., the UE 1402 is tuning to the ABWP 1403 throughout the positioning session 1418).

In some examples, the retune gaps/BWP switch gaps may be very small compared to measurement gaps/measurement window. For example, retune gaps may be in an order of symbol durations whereas measurement gaps may be in an order of couple of milliseconds (e.g., the retune time for a UE in frequency range 1 (FR1) may be 0.5 ms). In other words, ABWP switching (e.g., used by the retune gaps) may be faster than the retune used for measurement gaps.

In another aspect of the present disclosure, for a UE to apply aspects discussed in connection with FIGS. 11 to 14, the UE may provide its RF capability to an LMF. For example, as different UEs may have different retune measurement gaps/retune BWP gap specifications, a UE (e.g., the UE 1102, 1402) may provide its retune measurement gaps/retune BWP gap duration to an LMF. In response, the LMF may negotiate with the serving base station of the UE and provide measurement gaps/retune BWP gaps near PRS occasion(s). Note that while the UE is retuning, the ABWP may still remain the same as before the retuning.

In another aspect of the present disclosure, for a UE to apply aspects discussed in connection with FIGS. 11 to 14, the UE (e.g., the UE 1102, 1402) and/or the serving base station of the UE may provide information associated with the ABWP (e.g., the ABWP's bandwidth, configuration, timing, etc.) to the LMF. In response, the LMF may use this formation to schedule a larger PRS BW/BW PFL near the ABWP.

In another aspect of the present disclosure, a UE (e.g., the UE 1102, 1402) may be configured not to reduce the PRS BW (e.g., as described in connection with FIG. 11) if the UE is moving at a speed/velocity above a speed/velocity threshold (e.g., greater than 70 miles per hour) and/or the UE may be configured to reduce the PRS BW if the UE is moving at a speed/velocity below a speed/velocity threshold (e.g., less than 50 miles per hour), etc. The UE may use one or more stationary sensors and/or motion sensors to obtain the UE's speed and/or velocity. In other words, if the UE is moving with higher speed, the UE may not reduce the PRS BW for processing, whereas if the UE is moving with lower speed, the UE may reduce the PRS BW for processing.

In another aspect of the present disclosure, the set of PRSs measured by a UE (e.g., the UE 1102, 1402) in association with aspects discussed in connection with FIGS. 11 to 14 may be associated with multiple PFLs, where each PFL may be used by multiple base stations for transmitting PRS. For example, a UE may indicate a number of PFLs it is capable of supporting when the UE sends the network its positioning capabilities, such as during a positioning protocol session. In other words, while camping on a serving ABWP, if a UE has sufficient processing power, the UE may be able to perform multiple PFL measurements and processing simultaneously.

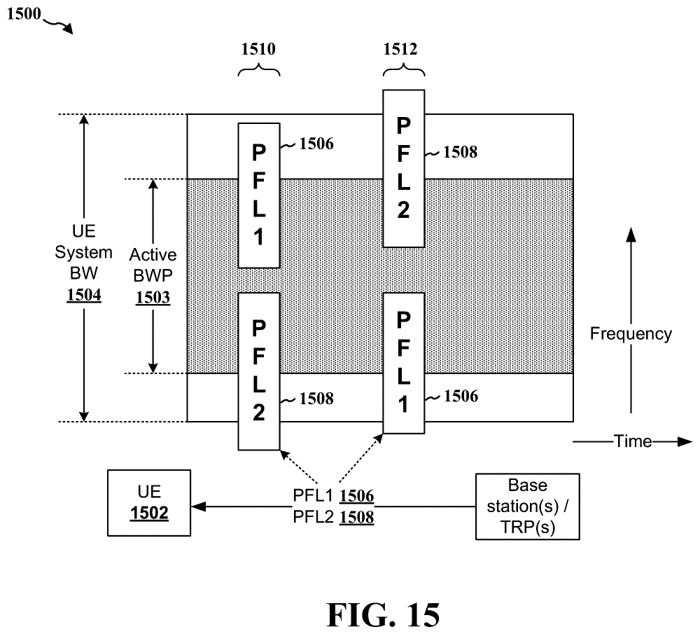

FIG. 15 is a diagram 1500 illustrating an example of a UE performing multiple PFL measurements in accordance with various aspects of the present disclosure. A UE 1502 (e.g., the UE 1102, 1402) may be configured with an ABWP 1503, where the bandwidth of the ABWP 1503 may be smaller than a UE system bandwidth 1504. The UE 1502 may be configured to tune to the ABWP 1503 for a default bandwidth to conserve power (e.g., the UE 1502 monitors/measures the channel using the bandwidth of the ABWP 1503).

In one example, as shown at 1510 and 1512, the UE 1502 may be configured to measure a first PFL 1506 (“PFL 1”) and a second PFL 1508 (“PFL 2”) simultaneously where the first PFL 1506 and the second PFL 1508 may be transmitted from different base stations and/or TRPs. After the UE 1502 measures the first PFL 1506 and the second PFL 1508, the UE 1502 may process the first PFL 1506 and the second PFL 1508 simultaneously (or separately), and the UE 1502 may transmit the processing result to a serving base station and/or the associated LMF.

In one aspect, the UE 1502 may be configured to determine an overlap metric (or the UE 1502 may be configured with an overlap metric) for each PFL that is to be measured simultaneously. Then, if at least one PFL's overlap metric does not meet an overlap threshold (e.g., overlap metric<overlap threshold), then the UE 1502 may be configured to request a measurement gap from the serving base station.

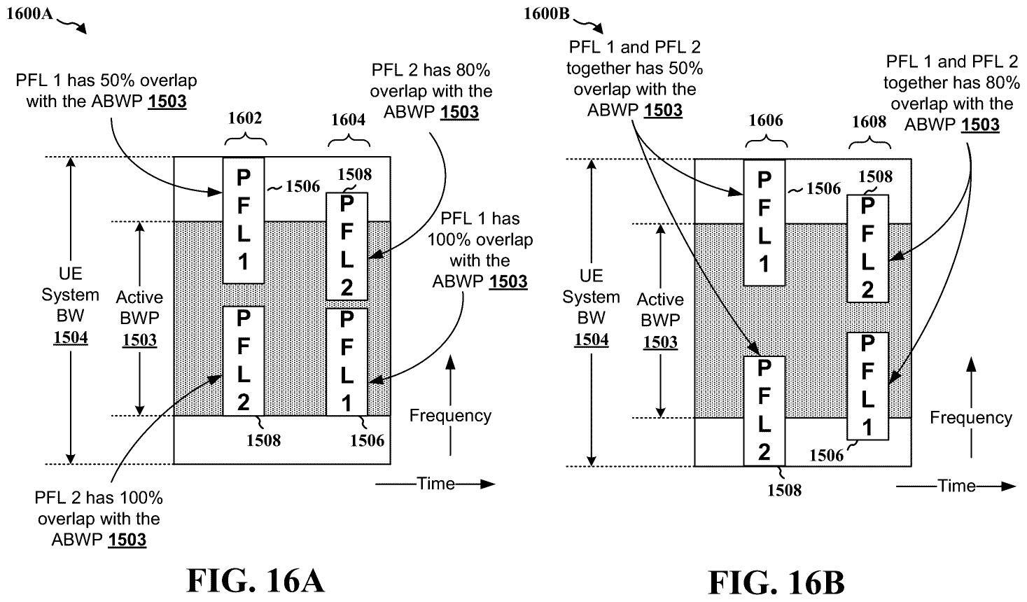

For example, as shown by a diagram 1600A of FIG. 16A, at a PFL measurement instance 1602, the first PFL 1506 may overlap with the ABWP 1503 by 50%, and the second PFL 1508 may overlap with the ABWP by 100%. If an overlap metric associated with the first PFL 1506 and the second PFL 1508 indicates that each PFL should have at least 70% overlap (e.g., overlap threshold=70%) with the ABWP for a gap less measurement (e.g., the UE 1502 may skip requesting a measurement gap if each PFL to be measured has at least 70% overlap with the ABWP 1503), then the UE 1502 may be configured to request a measurement gap from the serving base station for the PFL measurement instance 1602 as at least the first PFL 1506 does not overlap the ABWP 1503 by 70%. On the other hand, at a PFL measurement instance 1604, the first PFL 1506 may overlap with the ABWP 1503 by 100%, and the second PFL 1508 may overlap with the ABWP by 80%. As both PFLs exceed the overlap threshold of 70%, the UE 1502 may be configured to measure the first PFL 1506 and the second PFL1508 without requesting a measurement gap from the serving base station (e.g., the UE 1502 may perform gap less measurements).

In another aspect, the UE 1502 may be configured to determine an overlap metric (or the UE 1502 may be configured with an overlap metric) for a union/aggregation of bandwidth across all PFLs that are to be measured simultaneously. Then, if the union/aggregation of bandwidth across all PFLs does not meet an overlap threshold (e.g., overlap metric<overlap threshold), then the UE 1502 may be configured to request a measurement gap from the serving base station.

For example, as shown by a diagram 1600B of FIG. 16B, at a PFL measurement instance 1606, the first PFL 1506 and the second PFL 1508 in union/aggregation may overlap with the ABWP 1503 by 50%. If the overlap threshold associated with the overlap metric is configured to be 70% for a gap less measurement (e.g., the UE 1502 may skip requesting a measurement gap if the total bandwidth of multiple PFLs has at least 70% overlap with the ABWP 1503), then the UE 1502 may be configured to request a measurement gap from the serving base station for the PFL measurement instance 1606 as the first PFL 1506 and the second PFL 1508 in union/aggregation do not overlap the ABWP 1503 by 70%. On the other hand, at a PFL measurement instance 1608, the first PFL 1506 and the second PFL 1508 in union/aggregation may overlap with the ABWP 1503 by 80%. As the overlap exceeds the overlap threshold of 70%, the UE 1502 may be configured to measure the first PFL 1506 and the second PFL1508 without requesting a measurement gap from the serving base station (e.g., the UE 1502 may perform gap less measurements for the first PFL 1506 and the second PFL1508). In some examples, if multiple PFLs (e.g., two PFLs) are expected to be processed coherently and determine a single positioning measurement (e.g., a single TOA), then having a single overlap-metric & a single threshold may be more appropriate.

In another example, the UE 1502 may report threshold(s) on the overlap metric for deciding whether MG is specified or not to an LMF (e.g., as part of the RF capability reporting). In other examples, the UE 1502 may receive configuration for the threshold(s) on the overlap metric from a serving base station or the LMF.

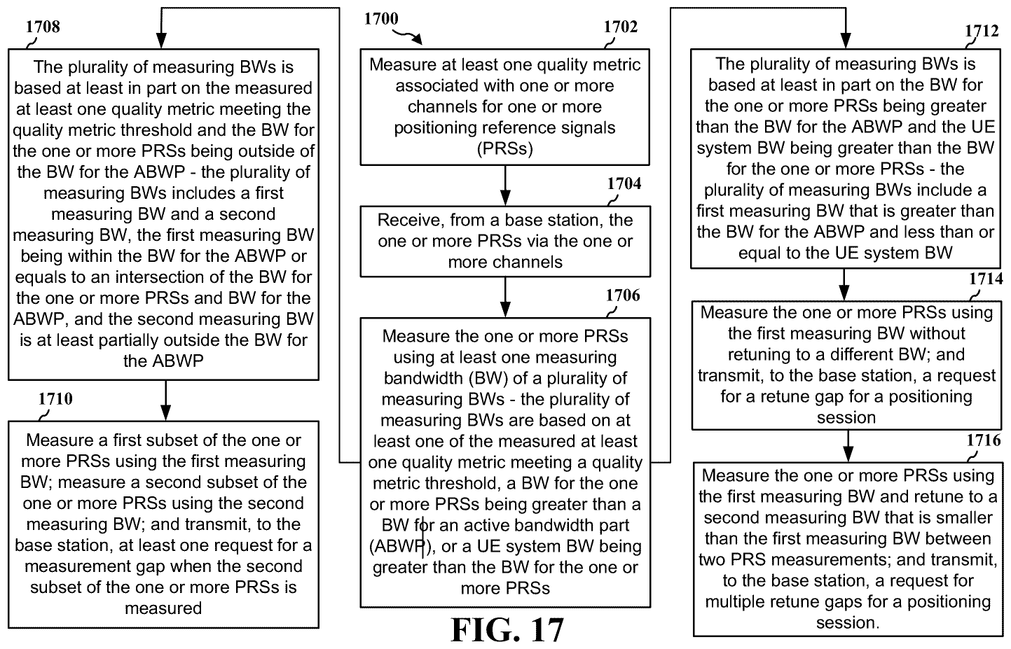

FIG. 17 is a flowchart 1700 of a method of wireless communication. The method may be performed by a UE or a component of a UE (e.g., the UE 104, 350, 404, 602, 702, 704, 706, 1002, 1102, 1402, 1502; the apparatus 1902; a processing system, which may include the memory 360 and which may be the entire UE 350 or a component of the UE 350, such as the TX processor 368, the RX processor 356, and/or the controller/processor 359). The method may enable the UE to measure a subset/portion of a bandwidth of a set of PRSs if one or more defined conditions are met, such that the UE may measure the set of PRSs without retuning to a larger bandwidth from a default bandwidth if the bandwidth of the set of PRSs exceeds the default bandwidth. The method may also enable the UE to determine whether to request or refrain from requesting measurement gaps and/or retune gaps.

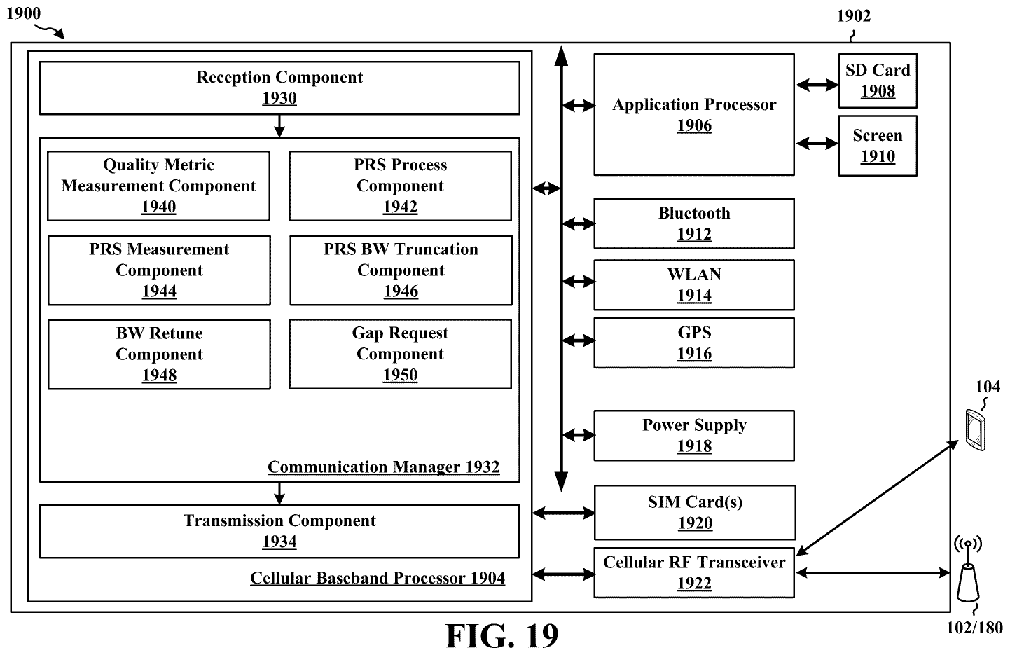

At 1702, the UE may measure at least one quality metric associated with one or more channels for one or more PRSs, such as described in connection with FIG. 11. For example, at 1105, the UE 1102 may measure at least one quality metric associated with one or more channels for a set of PRSs. The measurement of the SNR associated with one or more channels for one or more PRSs may be performed by, e.g., the quality metric measurement component 1940 and/or the reception component 1930 of the apparatus 1902 in FIG. 19. In one example, the at least one quality metric may include one or more of SNR, SINR, RSRP, or LOS or NLOS condition associated with the one or more channels.

At 1704, the UE may receive, from a base station, the one or more PRSs via the one or more channels, such as described in connection with FIG. 11. For example, at 1107, the UE 1102 may receive the set of PRSs, such as from one or more base station(s) and/or TRPs, via the one or more channels. The reception of the one or more PRSs may be performed by, e.g., the PRS process component 1942 and/or the reception component 1930 of the apparatus 1902 in FIG. 19.

At 1706, the UE may measure the one or more PRSs using at least one measuring BW of a plurality of measuring BWs, the plurality of measuring BWs being based on at least one of the measured at least one quality metric meeting a quality metric threshold, a BW for the one or more PRSs being greater than or outside of a BW for an ABWP, or a UE system BW being greater than the BW for the one or more PRSs, such as described in connection with FIGS. 11, 12A, 12B, 14, 15, 16A, and 16B. For example, at 1108, if the bandwidth of the set of PRSs that is to be measured by the UE 1102 is greater than the bandwidth of the ABWP 1103 and the channel condition associated with channel(s) for the set of PRSs meets a threshold, the UE 1102 may be configured to measure a subset/portion of the PRSs, such as the subset/portion that overlaps with the ABWP 1103. The measurement of the one or more PRSs using at least one measuring BW of a plurality of measuring BWs may be performed by, e.g., the PRS measurement component 1944 and/or the reception component 1930 of the apparatus 1902 in FIG. 19.

In one aspect, as shown at 1708, the plurality of measuring BWs may be based at least in part on the measured at least one quality metric meeting the quality metric threshold and the BW for the one or more PRSs being outside of the BW for the ABWP, where the plurality of measuring BWs may include a first measuring BW and a second measuring BW, the first measuring BW being less than or equal to the BW for the ABWP, and the second measuring BW being greater than or outside of the BW for the ABWP, such as described in connection with FIG. 11.

At 1710, the UE may measure a first subset of the one or more PRSs using the first measuring BW, measure a second subset of the one or more PRSs using the second measuring BW, and transmit, to the base station, at least one request for a measurement gap when the second subset of the one or more PRSs is measured, such as described in connection with FIG. 11. The measurement of the first subset and the second subset of the one or more PRSs may be performed by, e.g., the PRS BW truncation component 1946, the PRS measurement component 1944, and/or the reception component 1930 of the apparatus 1902 in FIG. 19. The transmission of the at least one request for a measurement gap may be performed by, e.g., the gap request component 1950 and/or the transmission component 1934 of the apparatus 1902 in FIG. 19. In one example, the UE may refrain from requesting the measurement gap when the first subset of the one or more PRSs is measured.

In another example, the UE may transmit, to an LMF, a measurement gap duration associated with the measurement gap, and the UE may receive, from the base station, a configuration for the measurement gap based at least in part on the transmitted measurement gap duration.

In another example, the one or more PRSs may be measured using the first measuring BW if the UE is moving at a velocity or speed below a velocity threshold, and where the one or more PRSs are measured using the second measuring BW if the UE is moving at a velocity or speed above the velocity threshold.

In another example, the one or more PRSs may be measured using the second measuring BW if the BW for the one or more PRSs exceeds the BW for the ABWP by a BW threshold or a percentage threshold. In such an example, the UE may receive, from the base station, a configuration for the BW threshold or the percentage threshold.

In another aspect, as shown at 1712, the plurality of measuring BWs may be based at least in part on the BW for the one or more PRSs being greater than or outside of the BW for the ABWP and the UE system BW being greater than the BW for the one or more PRSs, where the plurality of measuring BWs may include a first measuring BW that is greater than the BW for the ABWP and less than or equal to the UE system BW, such as described in connection with FIG. 14. In one example, the UE may transmit, to an LMF, a retune gap duration associated with one or more retune gaps, and the UE may receive, from the base station, a configuration for the one or more retune gaps based at least in part on the transmitted retune gap duration. In another example, the first measuring BW may be greater than or equal to the BW for the one or more PRSs if the UE is moving at a velocity or speed above a velocity threshold.

In one example, at 1714, the UE may measure the one or more PRSs using the first measuring BW without retuning to a different BW, and the UE may transmit, to the base station, a request for a retune gap for a positioning session, such as described in connection with FIG. 14. For example, at 1412, the UE 1402 may be configured to tune to a measuring bandwidth greater than the ABWP 1403 and smaller than the UE system bandwidth 1404 throughout a positioning session 1418. In such a configuration, the UE 1402 may request one set of retune gaps/BWP switch gaps from the serving base station for switching from the ABWP 1403 to the PRS BW 1406 and switching back to the ABWP 1403 (after measurement). The measurement of the one or more PRSs may be performed by, e.g., the BW retune component 1948, the PRS measurement component 1944, and/or the reception component 1930 of the apparatus 1902 in FIG. 19. The transmission of the request for one set of retune gaps/BWP switch gaps may be performed by, e.g., the gap request component 1950 and/or the transmission component 1934 of the apparatus 1902 in FIG. 19.

In another example, at 1716, the UE may measure the one or more PRSs using the first measuring BW and retune to a second measuring BW that is smaller than the first measuring BW between two PRS measurements, and the UE may transmit, to the base station, a request for multiple retune gaps for a positioning session, such as described in connection with FIG. 14. For example, at 1414, the UE 1402 may be configured to tune to a measuring bandwidth greater than the ABWP 1403 and smaller than the UE system bandwidth 1404 near to (or prior to) one or more PRS measuring occasions in a positioning session 1418, and there may be no change in the serving cell ABWP 1403. In such a configuration, the UE 1402 may request multiple sets of retune gaps/BWP switch gaps from the serving base station for switching from the ABWP 1403 to the PRS BW 1406 and switching back to the ABWP 1403. The measurement of the one or more PRSs may be performed by, e.g., the BW retune component 1948, the PRS measurement component 1944, and/or the reception component 1930 of the apparatus 1902 in FIG. 19. The transmission of the request for one set of retune gaps/BWP switch gaps may be performed by, e.g., the gap request component 1950 and/or the transmission component 1934 of the apparatus 1902 in FIG. 19.

In another example, the UE may transmit, to an LMF, information associated with the ABWP, and the UE may receive, from the base station, a configuration associated with a BW PFL based at least in part on the transmitted information.

In another aspect, the one or more PRSs are associated with multiple BW PFLs. In one example, the UE may transmit, to the base station, a request for at least one measurement gap if at least one of the multiple BW PFLs does not overlap with the ABWP by an overlap threshold, such as described in connection with FIGS. 15 and 16A. In another example, the UE may transmit, to the base station, a request for at least one measurement gap if the multiple BW PFLs in aggregation do not overlap with the ABWP by an overlap threshold, such as described in connection with FIGS. 15 and 16B.

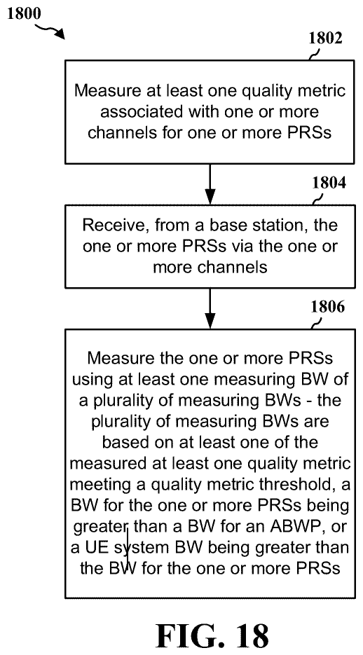

FIG. 18 is a flowchart 1800 of a method of wireless communication. The method may be performed by a UE or a component of a UE (e.g., the UE 104, 350, 404, 602, 702, 704, 706, 1002, 1102, 1402, 1502; the apparatus 1902; a processing system, which may include the memory 360 and which may be the entire UE 350 or a component of the UE 350, such as the TX processor 368, the RX processor 356, and/or the controller/processor 359). The method may enable the UE to measure a subset/portion of a bandwidth of a set of PRSs if one or more defined conditions are met, such that the UE may measure the set of PRSs without retuning to a larger bandwidth from a default bandwidth if the bandwidth of the set of PRSs exceeds the default bandwidth. The method may also enable the UE to determine whether to request or refrain from requesting measurement gaps and/or retune gaps.

At 1802, the UE may measure at least one quality metric associated with one or more channels for one or more PRSs, such as described in connection with FIG. 11. For example, at 1105, the UE 1102 may measure at least one quality metric associated with one or more channels for a set of PRSs. The measurement of the SNR associated with one or more channels for one or more PRSs may be performed by, e.g., the quality metric measurement component 1940 and/or the reception component 1930 of the apparatus 1902 in FIG. 19. In one example, the at least one quality metric may include one or more of SNR, SINR, RSRP, or LOS or NLOS condition associated with the one or more channels.

At 1804, the UE may receive, from a base station, the one or more PRSs via the one or more channels, such as described in connection with FIG. 11. For example, at 1107, the UE 1102 may receive the set of PRSs, such as from one or more base station(s) and/or TRPs, via the one or more channels. The reception of the one or more PRSs may be performed by, e.g., the PRS process component 1942 and/or the reception component 1930 of the apparatus 1902 in FIG. 19.

At 1806, the UE may measure the one or more PRSs using at least one measuring BW of a plurality of measuring BWs, the plurality of measuring BWs being based on at least one of the measured at least one quality metric meeting a quality metric threshold, a BW for the one or more PRSs being greater than or outside of a BW for an ABWP, or a UE system BW being greater than the BW for the one or more PRSs, such as described in connection with FIGS. 11, 12A, 12B, 14, 15, 16A, and 16B. For example, at 1108, if the bandwidth of the set of PRSs that is to be measured by the UE 1102 is greater than the bandwidth of the ABWP 1103 and the channel condition associated with channel(s) for the set of PRSs meets a threshold, the UE 1102 may be configured to measure a subset/portion of the PRSs, such as the subset/portion that overlaps with the ABWP 1103. The measurement of the one or more PRSs using at least one measuring BW of a plurality of measuring BWs may be performed by, e.g., the PRS measurement component 1944 and/or the reception component 1930 of the apparatus 1902 in FIG. 19.

In one aspect, the plurality of measuring BWs may be based at least in part on the measured at least one quality metric meeting the quality metric threshold and the BW for the one or more PRSs being outside of the BW for the ABWP, where the plurality of measuring BWs includes a first measuring BW and a second measuring BW, the first measuring BW being within the BW for the ABWP or equals to an intersection of the BW for the one or more PRSs and BW for the ABWP, and the second measuring BW is at least partially outside the BW for the ABWP, such as described in connection with FIG. 11.

In one example, the UE may measure a first subset of the one or more PRSs using the first measuring BW, measure a second subset of the one or more PRSs using the second measuring BW, and transmit, to the base station, at least one request for a measurement gap when the second subset of the one or more PRSs is measured, such as described in connection with FIG. 11. The measurement of the first subset and the second subset of the one or more PRSs may be performed by, e.g., the PRS BW truncation component 1946, the PRS measurement component 1944, and/or the reception component 1930 of the apparatus 1902 in FIG. 19. The transmission of the at least one request for a measurement gap may be performed by, e.g., the gap request component 1950 and/or the transmission component 1934 of the apparatus 1902 in FIG. 19. In one example, the UE may refrain from requesting the measurement gap when the first subset of the one or more PRSs is measured.

In another example, the UE may transmit, to an LMF, a measurement gap duration associated with the measurement gap, and the UE may receive, from the base station, a configuration for the measurement gap based at least in part on the transmitted measurement gap duration.

In another example, the one or more PRSs may be measured using the first measuring BW if the UE is moving at a velocity or speed below a velocity threshold, and where the one or more PRSs are measured using the second measuring BW if the UE is moving at a velocity or speed above the velocity threshold.

In another example, the one or more PRSs may be measured using the second measuring BW if the BW for the one or more PRSs exceeds the BW for the ABWP by a BW threshold or a percentage threshold. In such an example, the UE may receive, from the base station, a configuration for the BW threshold or the percentage threshold.

In another aspect, the plurality of measuring BWs may be based at least in part on the BW for the one or more PRSs being greater than or outside of the BW for the ABWP and the UE system BW being greater than the BW for the one or more PRSs, where the plurality of measuring BWs may include a first measuring BW that is greater than the BW for the ABWP and less than or equal to the UE system BW, such as described in connection with FIG. 14. In one example, the UE may transmit, to an LMF, a retune gap duration associated with one or more retune gaps, and the UE may receive, from the base station, a configuration for the one or more retune gaps based at least in part on the transmitted retune gap duration. In another example, the first measuring BW may be greater than or equal to the BW for the one or more PRSs if the UE is moving at a velocity or speed above a velocity threshold.

In one example, the UE may measure the one or more PRSs using the first measuring BW without retuning to a different BW, and the UE may transmit, to the base station, a request for a retune gap for a positioning session, such as described in connection with FIG. 14. For example, at 1412, the UE 1402 may be configured to tune to a measuring bandwidth greater than the ABWP 1403 and smaller than the UE system bandwidth 1404 throughout a positioning session 1418. In such a configuration, the UE 1402 may request one set of retune gaps/BWP switch gaps from the serving base station for switching from the ABWP 1403 to the PRS BW 1406 and switching back to the ABWP 1403 (after measurement). The measurement of the one or more PRSs may be performed by, e.g., the BW retune component 1948, the PRS measurement component 1944, and/or the reception component 1930 of the apparatus 1902 in FIG. 19. The transmission of the request for one set of retune gaps/BWP switch gaps may be performed by, e.g., the gap request component 1950 and/or the transmission component 1934 of the apparatus 1902 in FIG. 19.

In another example, the UE may measure the one or more PRSs using the first measuring BW and retune to a second measuring BW that is smaller than the first measuring BW between two PRS measurements, and the UE may transmit, to the base station, a request for multiple retune gaps for a positioning session, such as described in connection with FIG. 14. For example, at 1414, the UE 1402 may be configured to tune to a measuring bandwidth greater than the ABWP 1403 and smaller than the UE system bandwidth 1404 near to (or prior to) one or more PRS measuring occasions in a positioning session 1418, and there may be no change in the serving cell ABWP 1403. In such a configuration, the UE 1402 may request multiple sets of retune gaps/BWP switch gaps from the serving base station for switching from the ABWP 1403 to the PRS BW 1406 and switching back to the ABWP 1403. The measurement of the one or more PRSs may be performed by, e.g., the BW retune component 1948, the PRS measurement component 1944, and/or the reception component 1930 of the apparatus 1902 in FIG. 19. The transmission of the request for one set of retune gaps/BWP switch gaps may be performed by, e.g., the gap request component 1950 and/or the transmission component 1934 of the apparatus 1902 in FIG. 19.

In another example, the UE may transmit, to an LMF, information associated with the ABWP, and the UE may receive, from the base station, a configuration associated with a BW PFL based at least in part on the transmitted information.

In another aspect, the one or more PRSs are associated with multiple BW PFLs. In one example, the UE may transmit, to the base station, a request for at least one measurement gap if at least one of the multiple BW PFLs does not overlap with the ABWP by an overlap threshold, such as described in connection with FIGS. 15 and 16A. In another example, the UE may transmit, to the base station, a request for at least one measurement gap if the multiple BW PFLs in aggregation do not overlap with the ABWP by an overlap threshold, such as described in connection with FIGS. 15 and 16B.

FIG. 19 is a diagram 1900 illustrating an example of a hardware implementation for an apparatus 1902. The apparatus 1902 may be a UE, a component of a UE, or may implement UE functionality. In some aspects, the apparatus 1902 may include a cellular baseband processor 1904 (also referred to as a modem) coupled to a cellular RF transceiver 1922. In some aspects, the apparatus 1902 may further include one or more subscriber identity modules (SIM) cards 1920, an application processor 1906 coupled to a secure digital (SD) card 1908 and a screen 1910, a Bluetooth module 1912, a wireless local area network (WLAN) module 1914, a Global Positioning System (GPS) module 1916, or a power supply 1918. The cellular baseband processor 1904 communicates through the cellular RF transceiver 1922 with the UE 104 and/or BS 102/180. The cellular baseband processor 1904 may include a computer-readable medium/memory. The computer-readable medium/memory may be non-transitory. The cellular baseband processor 1904 is responsible for general processing, including the execution of software stored on the computer-readable medium/memory. The software, when executed by the cellular baseband processor 1904, causes the cellular baseband processor 1904 to perform the various functions described supra. The computer-readable medium/memory may also be used for storing data that is manipulated by the cellular baseband processor 1904 when executing software. The cellular baseband processor 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the cellular baseband processor 1904. The cellular baseband processor 1904 may be a component of the UE 350 and may include the memory 360 and/or at least one of the TX processor 368, the RX processor 356, and the controller/processor 359. In one configuration, the apparatus 1902 may be a modem chip and include just the baseband processor 1904, and in another configuration, the apparatus 1902 may be the entire UE (e.g., see 350 of FIG. 3) and include the additional modules of the apparatus 1902.

The communication manager 1932 includes a quality metric measurement component 1940 that is configured to measure at least one quality metric associated with one or more channels for one or more PRSs, e.g., as described in connection with 1702 of FIGS. 17 and/or 1802 of FIG. 18. The communication manager 1932 further includes a PRS process component 1942 that is configured to receive, from a base station, the one or more PRSs via the one or more channels, e.g., as described in connection with 1704 of FIGS. 17 and/or 1804 of FIG. 18. The communication manager 1932 further includes a PRS measurement component 1944 that is configured to measure the one or more PRSs using at least one measuring BW of a plurality of measuring BWs, the plurality of measuring BWs being based on at least one of the measured at least one quality metric meeting a quality metric threshold, a BW for the one or more PRSs being greater than or outside of a BW for an ABWP, or a UE system BW being greater than the BW for the one or more PRSs, e.g., as described in connection with 1706 of FIGS. 17 and/or 1806 of FIG. 18. The communication manager 1932 further includes a PRS BW truncation component 1946 that is configured to measure a first subset of the one or more PRSs using the first measuring BW and/or measure a second subset of the one or more PRSs using the second measuring BW, e.g., as described in connection with 1710 of FIG. 17. The communication manager 1932 further includes a gap request component 1950 that is configured to transmit, to the base station, at least one request for a measurement gap when the second subset of the one or more PRSs is measured, e.g., as described in connection with 1710 of FIG. 17. The communication manager 1932 further includes a BW retune component 1948 that is configured to measure the one or more PRSs using the first measuring BW without retuning to a different BW, e.g., as described in connection with 1714 of FIG. 17. The BW retune component 1948 may also be configured to measure the one or more PRSs using the first measuring BW and retune to a second measuring BW that is smaller than the first measuring BW between two PRS measurements, e.g., as described in connection with 1716 of FIG. 17. The gap request component 1950 may also be configured to transmit, to the base station, a request for a retune gap for a positioning session, or a request for multiple retune gaps for a positioning session, e.g., as described in connection with 1714 and 1716 of FIG. 17.

The apparatus may include additional components that perform each of the blocks of the algorithm in the flowcharts of FIGS. 17 and 18. As such, each block in the flowcharts of FIGS. 17 and 18 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1902 may include a variety of components configured for various functions. In one configuration, the apparatus 1902, and in particular the cellular baseband processor 1904, includes means for measuring at least one quality metric associated with one or more channels for one or more PRSs (e.g., the Quality metric measurement component 1940 and/or the reception component 1930). The apparatus 1902 includes means for receiving, from a base station, the one or more PRSs via the one or more channels (e.g., the PRS process component 1942 and/or the reception component 1930). The apparatus 1902 includes means for measuring the one or more PRSs using at least one measuring BW of a plurality of measuring BWs, the plurality of measuring BWs being based on at least one of the measured at least one quality metric meeting a quality metric threshold, a BW for the one or more PRSs being greater than or outside of a BW for an ABWP, or a UE system BW being greater than the BW for the one or more PRSs (e.g., the PRS measurement component 1944 and/or the reception component 1930). The apparatus 1902 includes means for measuring a first subset of the one or more PRSs using the first measuring BW and means for measuring a second subset of the one or more PRSs using the second measuring BW (e.g., the PRS BW truncation component 1946, the PRS measurement component 1944, and/or the reception component 1930). The apparatus 1902 includes means for transmitting, to the base station, at least one request for a measurement gap when the second subset of the one or more PRSs is measured (e.g., the gap request component 1950 and/or the transmission component 1934). The apparatus 1902 includes means for measuring the one or more PRSs using the first measuring BW without retuning to a different BW and/or means for measuring the one or more PRSs using the first measuring BW and means for retuning to a second measuring BW that is smaller than the first measuring BW between two PRS measurements (e.g., the BW retune component 1948, the PRS measurement component 1944, and/or the reception component 1930). The apparatus 1902 includes means for transmitting, to the base station, a request for a retune gap for a positioning session and/or means for transmitting, to the base station, a request for multiple retune gaps for a positioning session (e.g., the gap request component 1950, and/or the transmission component 1934).

The means may be one or more of the components of the apparatus 1902 configured to perform the functions recited by the means. As described supra, the apparatus 1902 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to measure at least one quality metric associated with one or more channels for one or more PRSs; receive, from a base station, the one or more PRSs via the one or more channels; and measure the one or more PRSs using at least one measuring BW of a plurality of measuring BWs, the plurality of measuring BWs being based on at least one of the measured at least one quality metric meeting a quality metric threshold, a BW for the one or more PRSs being greater than or outside of a BW for an ABWP, or a UE system BW being greater than the BW for the one or more PRSs.

Aspect 2 is the apparatus of aspect 1, where the plurality of measuring BWs is based at least in part on the measured at least one quality metric meeting the quality metric threshold and the BW for the one or more PRSs being greater than or outside of the BW for the ABWP.

Aspect 3 is the apparatus of any of aspects 1 and 2, where the plurality of measuring BWs includes a first measuring BW and a second measuring BW, the first measuring BW being within the BW for the ABWP or equals to an intersection of the BW for the one or more PRSs and BW for the ABWP, and the second measuring BW is at least partially outside the BW for the ABWP.

Aspect 4 is the apparatus of any of aspects 1 to 3, where the at least one processor and the memory are further configured to: measure a first subset of the one or more PRSs using the first measuring BW; measure a second subset of the one or more PRSs using the second measuring BW; and transmit, to the base station, at least one request for a measurement gap when the second subset of the one or more PRSs is measured.

Aspect 5 is the apparatus of any of aspects 1 to 4, where the at least one processor and the memory are further configured to: refrain from requesting the measurement gap when the first subset of the one or more PRSs is measured.

Aspect 6 is the apparatus of any of aspects 1 to 5, where the at least one processor and the memory are further configured to: transmit, to an LMF, a measurement gap duration associated with the measurement gap; and receive, from the base station, a configuration for the measurement gap based at least in part on the transmitted measurement gap duration.

Aspect 7 is the apparatus of any of aspects 1 to 6, where the one or more PRSs are measured using the first measuring BW if the UE is moving at a velocity or speed below a velocity threshold, and where the one or more PRSs are measured using the second measuring BW if the UE is moving at a velocity or speed above the velocity threshold.

Aspect 8 is the apparatus of any of aspects 1 to 7, where the one or more PRSs are measured using the second measuring BW if the BW for the one or more PRSs exceeds the BW for the ABWP by a BW threshold or a percentage threshold.

Aspect 9 is the apparatus of any of aspects 1 to 8, where the at least one processor and the memory are further configured to: receive, from the base station, a configuration for the BW threshold or the percentage threshold.

Aspect 10 is the apparatus of any of aspects 1 to 9, where the plurality of measuring BWs is based at least in part on the BW for the one or more PRSs being greater than or outside of the BW for the ABWP and the UE system BW being greater than the BW for the one or more PRSs.

Aspect 11 is the apparatus of any of aspects 1 to 10, where the plurality of measuring BWs include a first measuring BW that is greater than the BW for the ABWP and less than or equal to the UE system BW.

Aspect 12 is the apparatus of any of aspects 1 to 11, where the at least one processor and the memory are further configured to: measure the one or more PRSs using the first measuring BW without retuning to a different BW; and transmit, to the base station, a request for a retune gap for a positioning session.

Aspect 13 is the apparatus of any of aspects 1 to 12, where the at least one processor and the memory are further configured to: measure the one or more PRSs using the first measuring BW and retune to a second measuring BW that is smaller than the first measuring BW between two PRS measurements; and transmit, to the base station, a request for multiple retune gaps for a positioning session.

Aspect 14 is the apparatus of any of aspects 1 to 13, where the at least one processor and the memory are further configured to: transmit, to an LMF, a retune gap duration associated with one or more retune gaps; and receive, from the base station, a configuration for the one or more retune gaps based at least in part on the transmitted retune gap duration.

Aspect 15 is the apparatus of any of aspects 1 to 14, where the first measuring BW is greater than or equal to the BW for the one or more PRSs if the UE is moving at a velocity or speed above a velocity threshold.

Aspect 16 is the apparatus of any of aspects 1 to 15, where the at least one processor and the memory are further configured to: transmit, to an LMF, information associated with the ABWP; and receive, from the base station, a configuration associated with a BW PFL based at least in part on the transmitted information.

Aspect 17 is the apparatus of any of aspects 1 to 16, where the one or more PRSs are associated with multiple BW PFLs.

Aspect 18 is the apparatus of any of aspects 1 to 17, where the at least one processor and the memory are further configured to: transmit, to the base station, a request for at least one measurement gap if at least one of the multiple BW PFLs does not overlap with the ABWP by an overlap threshold.

Aspect 19 is the apparatus of any of aspects 1 to 18, where the at least one processor and the memory are further configured to: transmit, to the base station, a request for at least one measurement gap if the multiple BW PFLs in aggregation do not overlap with the ABWP by an overlap threshold.

Aspect 20 is the apparatus of any of aspects 1 to 19, where the at least one quality metric includes one or more of SNR, SINR, RSRP, or LOS or NLOS condition associated with the one or more channels.

Aspect 21 is the apparatus of any of aspects 1 to 20, further including a transceiver coupled to the at least one processor.

Aspect 22 is a method of wireless communication for implementing any of aspects 1 to 21.

Aspect 23 is an apparatus for wireless communication including means for implementing any of aspects 1 to 21.

Aspect 24 is a computer-readable medium storing computer executable code, where the code when executed by a processor causes the processor to implement any of aspects 1 to 21.

What is claimed is:

1. An apparatus for wireless communication at a user equipment (UE), comprising:
a memory;
a transceiver; and
at least one processor communicatively connected to the memory and the transceiver, the at least one processor configured to:
measure at least one quality metric associated with one or more channels for one or more positioning reference signals (PRSs);
receive, from a base station, the one or more PRSs via the one or more channels; and
measure the one or more PRSs using at least one measuring bandwidth (BW) of a plurality of measuring BWs, the plurality of measuring BWs being based on at least one of the measured at least one quality metric meeting a quality metric threshold, a BW for the one or more PRSs being greater than or outside of a BW for an active bandwidth part (ABWP), or a UE system BW being greater than the BW for the one or more PRSs.

2. The apparatus of claim 1, wherein the plurality of measuring BWs is based at least in part on the measured at least one quality metric meeting the quality metric threshold and the BW for the one or more PRSs being greater than or outside of the BW for the ABWP.

3. The apparatus of claim 2, wherein the plurality of measuring BWs includes a first measuring BW and a second measuring BW, the first measuring BW being within the BW for the ABWP or equals to an intersection of the BW for the one or more PRSs and BW for the ABWP, and the second measuring BW is at least partially outside the BW for the ABWP.

4. The apparatus of claim 3, wherein the at least one processor is further configured to:
measure a first subset of the one or more PRSs using the first measuring BW;
measure a second subset of the one or more PRSs using the second measuring BW; and
transmit, to the base station, at least one request for a measurement gap when the second subset of the one or more PRSs is measured.

5. The apparatus of claim 4, wherein the at least one processor is further configured to:
refrain from requesting the measurement gap when the first subset of the one or more PRSs is measured.

6. The apparatus of claim 4, wherein the at least one processor is further configured to:
transmit, to a location management function (LMF), a measurement gap duration associated with the measurement gap; and
receive, from the base station, a configuration for the measurement gap based at least in part on the transmitted measurement gap duration.

7. The apparatus of claim 3, wherein the one or more PRSs are measured using the first measuring BW if the UE is moving at a velocity or speed below a velocity threshold, and wherein the one or more PRSs are measured using the second measuring BW if the UE is moving at a velocity or speed above the velocity threshold.

8. The apparatus of claim 3, wherein the one or more PRSs are measured using the second measuring BW if the BW for the one or more PRSs exceeds the BW for the ABWP by a BW threshold or a percentage threshold.

9. The apparatus of claim 8, wherein the at least one processor is further configured to:
receive, from the base station, a configuration for the BW threshold or the percentage threshold.

10. The apparatus of claim 1, wherein the plurality of measuring BWs is based at least in part on the BW for the one or more PRSs being greater than or outside of the BW for the ABWP and the UE system BW being greater than the BW for the one or more PRSs.

11. The apparatus of claim 10, wherein the plurality of measuring BWs includes a first measuring BW that is greater than the BW for the ABWP and less than or equal to the UE system BW.

12. The apparatus of claim 11, wherein the at least one processor is further configured to:
measure the one or more PRSs using the first measuring BW without retuning to a different BW; and
transmit, to the base station, a request for a retune gap for a positioning session.

13. The apparatus of claim 11, wherein the at least one processor is further configured to:
measure the one or more PRSs using the first measuring BW and retune to a second measuring BW that is smaller than the first measuring BW between two PRS measurements; and
transmit, to the base station, a request for multiple retune gaps for a positioning session.

14. The apparatus of claim 11, wherein the at least one processor is further configured to:
transmit, to a location management function (LMF), a retune gap duration associated with one or more retune gaps; and
receive, from the base station, a configuration for the one or more retune gaps based at least in part on the transmitted retune gap duration.

15. The apparatus of claim 11, wherein the first measuring BW is greater than or equal to the BW for the one or more PRSs if the UE is moving at a velocity or speed above a velocity threshold.

16. The apparatus of claim 1, wherein the at least one processor is further configured to:
transmit, to a location management function (LMF), information associated with the ABWP; and
receive, from the base station, a configuration associated with a BW positioning frequency layer (PFL) based at least in part on the transmitted information.

17. The apparatus of claim 1, wherein the one or more PRSs are associated with multiple BW positioning frequency layers (PFLs).

18. The apparatus of claim 17, wherein the at least one processor is further configured to:
transmit, to the base station, a request for at least one measurement gap if at least one of the multiple BW PFLs does not overlap with the ABWP by an overlap threshold.

19. The apparatus of claim 17, wherein the at least one processor is further configured to:
transmit, to the base station, a request for at least one measurement gap if the multiple BW PFLs in aggregation do not overlap with the ABWP by an overlap threshold.

20. The apparatus of claim 1, wherein the at least one quality metric includes one or more of signal-to-noise ratio (SNR), signal-to-interference-and-noise ratio (SINR), reference signal received power (RSRP), or line-of-sight (LOS) or non-line-of-sight (NLOS) condition associated with the one or more channels.

21. A method of wireless communication at a user equipment (UE), comprising:
measuring at least one quality metric associated with one or more channels for one or more positioning reference signals (PRSs);
receiving, from a base station, the one or more PRSs via the one or more channels; and
measuring the one or more PRSs using at least one measuring bandwidth (BW) of a plurality of measuring BWs, the plurality of measuring BWs being based on at least one of the measured at least one quality metric meeting a quality metric threshold, a BW for the one or more PRSs being greater than or outside of a BW for an active bandwidth part (ABWP), or a UE system BW being greater than the BW for the one or more PRSs.

22. The method of claim 21, wherein the plurality of measuring BWs is based at least in part on the measured at least one quality metric meeting the quality metric threshold and the BW for the one or more PRSs being outside of the BW for the ABWP, and wherein the plurality of measuring BWs includes a first measuring BW and a second measuring BW, the first measuring BW being within the BW for the ABWP or equals to an intersection of the BW for the one or more PRSs and BW for the ABWP, and the second measuring BW is at least partially outside the BW for the ABWP.

23. The method of claim 22, further comprising:
measuring a first subset of the one or more PRSs using the first measuring BW;
measuring a second subset of the one or more PRSs using the second measuring BW; and
transmitting, to the base station, at least one request for a measurement gap when the second subset of the one or more PRSs is measured.

24. The method of claim 23, further comprising:
refraining from requesting the measurement gap when the first subset of the one or more PRSs is measured.

25. The method of claim 21, wherein the plurality of measuring BWs is based at least in part on the BW for the one or more PRSs being greater than or outside of the BW for the ABWP and the UE system BW being greater than the BW for the one or more PRSs, and wherein the plurality of measuring BWs includes a first measuring BW that is greater than the BW for the ABWP and less than or equal to the UE system BW.

26. The method of claim 25, further comprising:
measuring the one or more PRSs using the first measuring BW without retuning to a different BW; and
transmitting, to the base station, a request for a retune gap for a positioning session.

27. The method of claim 25, further comprising:
measuring the one or more PRSs using the first measuring BW and retune to a second measuring BW that is smaller than the first measuring BW between two PRS measurements; and
transmitting, to the base station, a request for multiple retune gaps for a positioning session.

28. The method of claim 21, wherein the one or more PRSs are associated with multiple BW positioning frequency layers (PFLs), further comprising:
transmitting, to the base station, a request for at least one measurement gap if at least one of the multiple BW PFLs does not overlap with the ABWP by an overlap threshold, or
transmitting, to the base station, a request for at least one measurement gap if the multiple BW PFLs in aggregation do not overlap with the ABWP by an overlap threshold.

29. An apparatus for wireless communication at a user equipment (UE) comprising:
means for measuring at least one quality metric associated with one or more channels for one or more positioning reference signals (PRSs);
means for receiving, from a base station, the one or more PRSs via the one or more channels; and
means for measuring the one or more PRSs using at least one measuring bandwidth (BW) of a plurality of measuring BWs, the plurality of measuring BWs being based on at least one of the measured at least one quality metric meeting a quality metric threshold, a BW for the one or more PRSs being greater than or outside of a BW for an active bandwidth part (ABWP), or a UE system BW being greater than the BW for the one or more PRSs.

30. A computer-readable medium storing computer executable code at a user equipment (UE), the code when executed by a processor causes the processor to:
measure at least one quality metric associated with one or more channels for one or more positioning reference signals (PRSs);
receive, from a base station, the one or more PRSs via the one or more channels; and
measure the one or more PRSs using at least one measuring bandwidth (BW) of a plurality of measuring BWs, the plurality of measuring BWs being based on at least one of the measured at least one quality metric meeting a quality metric threshold, a BW for the one or more PRSs being greater than or outside of a BW for an active bandwidth part (ABWP), or a UE system BW being greater than the BW for the one or more PRSs.
